(19) United States
(12) Patent Application Publication
(10) Pub. No.: US 2025/0299545 A1
(43) Pub. Date: Sep. 25, 2025

(54) Door Lock Deter Light

(71) Applicant: Vivint LLC, Provo, UT (US)

(72) Inventors: Cecilee Petersen, Provo, UT (US); Stephen Boynton, Provo, UT (US); Austin Matsuura, Provo, UT (US); Rikki Price, Provo, UT (US); Kris Nosack, Provo, UT (US)

(73) Assignee: Vivint LLC, Provo, UT (US)

(21) Appl. No.: 19/083,802

(22) Filed: Mar. 19, 2025

Related U.S. Application Data
(60) Provisional application No. 63/567,830, filed on Mar. 20, 2024.

(51) Int. Cl. G08B 13/196; G08B 7/06; G08B 15/00

(52) U.S. Cl. CPC G08B 13/19606; G08B 7/06; G08B 13/19615; G08B 15/008

(57) ABSTRACT

Systems and methods for deterring a person at a door using a door lock deter light are disclosed. One method of deterring an unknown person at a door includes sensing that a person approaches a door at which an exterior door lock interface including an illumination device is located. The method further includes determining whether the person is unknown and, in response to determining that the person is unknown, activating the illumination device on the exterior door lock interface to be in a deterrence state. Otherwise, the method further includes activating the illumination device to be in a non-deterrence state or maintaining the illumination device in a deactivated state.

### CROSS REFERENCE

This application claims priority to U.S. Provisional Patent Application 63/567,830, filed Mar. 20, 2024, and entitled DOOR LOCK DETER LIGHT, which is incorporated by reference herein in its entirety.

### TECHNICAL FIELD

The current disclosure generally relates to smart home security systems.

### BACKGROUND

Various approaches have been developed for securing and controlling access to spaces with multiple doors. Traditional lock and key systems have been widely used, but they lack the convenience and flexibility of modern smart lock systems. Smart lock systems have emerged as a popular alternative, offering features such as remote access control, keyless entry, and integration with other smart home devices. A smart lock system often includes a smart lock controller that includes (i) a keypad mounted on an outside of a door and (ii) a thumb lock interface or adapter to a thumb turn or a deadbolt lever and installed on an inside door surface that communicates with the smart lock controller and is controlled thereby.

One approach involves using a single smart lock installed on the main entrance door of a space, such as a home or business. This smart lock is typically controlled through a mobile application or a centralized hub. While this approach provides convenience and enhanced security for the main entrance, it does not address the need for individual access control for multiple doors within the space. In situations where there are multiple doors of entry for entering different areas or rooms, smart locks may be installed on each door to enable independent access control. In other words, smart locks are installed on respective doors and operated independently to access entry into the space. While these systems may activate an alarm if a potential intruder enters or attempts to enter the home or business, users of smart lock systems may want to proactively discourage the potential intruder before the potential intruder attempts to enter the home or business.

### SUMMARY

The current disclosure relates to systems and methods for deterring a person at a door using a door lock deter light. The principles described herein are capable of enabling a smart lock system to actively deter a potential intruder and streamlining the deterrence process, thereby providing an additional layer of security for users of smart lock systems.

One method of deterring an unknown person at a door includes sensing that a person approaches a door at which an exterior door lock interface with an illumination device is located. The method further includes determining whether the person is unknown and, in response to determining that the person is unknown, activating the illumination device on the exterior door lock interface to be in a deterrence state. Otherwise, the method may further include activating the illumination device to be in a non-deterrence state or maintaining the illumination device in a deactivated state.

Another embodiment relates to a system for deterring an unknown person at a door, which may include an exterior door lock interface at the door with an illumination device and electronics including a sensor and processor(s). The electronics may be configured to sense, by the sensor, whether a person approaches the door and to determine, by the processor(s), whether the person is unknown. In response to determining that the person is unknown, the electronics may be further configured to activate, by the processor(s), the illumination device on the exterior door lock interface to be in a deterrence state. Otherwise, the electronics may be configured to deactivate, by the processor(s), the illumination device to be in a non-deterrence state (e.g., green illumination signal) or maintain, by the processor(s), the illumination device in a deactivated state (e.g., non-illuminated state).

### BRIEF DESCRIPTION OF THE FIGURES

A more complete understanding of the method and apparatus of the present invention may be obtained by reference to the following Detailed Description when taken in conjunction with the accompanying figures wherein:

FIG. 1 is a perspective view illustrating one embodiment of a security system inclusive of smart locks, according to an embodiment;

FIG. 2 is a block diagram of a multi-lock home kit, according to an embodiment;

FIG. 3A is a front view illustration of an illustrative primary smart lock including an exterior unit and an interior unit, according to an embodiment;

FIG. 3B is a front view illustration of an illustrative secondary smart lock optionally configured to communicate with the primary smart lock, according to an embodiment;

FIG. 4 is a block diagram of an illustrative system including a controller for use in controlling and operating one or more smart locks (or smart lock interfaces) and providing deterrence, according to an embodiment;

FIG. 5 is a perspective view illustration of an exterior smart lock interface inclusive of an illumination device, according to an embodiment;

FIG. 6 is a perspective view illustrating one embodiment of a system for deterring a person at a door using a door lock deter light, according to an embodiment;

FIG. 7 is a flowchart of an illustrative process for deterring a person at a door using a door lock deter light, according to an embodiment; and

FIG. 8 is a “swim-lane” flowchart of an illustrative process for deterring a person at a door and optionally contacting a monitoring service, according to an embodiment.

### DETAILED DESCRIPTION

Before turning to the figures, which illustrate certain illustrative embodiments in detail, it should be understood that the present disclosure is not limited to the details or methodology set forth in the description or illustrated in the figures. It should also be understood that the terminology used herein is for the purpose of description only and should not be regarded as limiting.

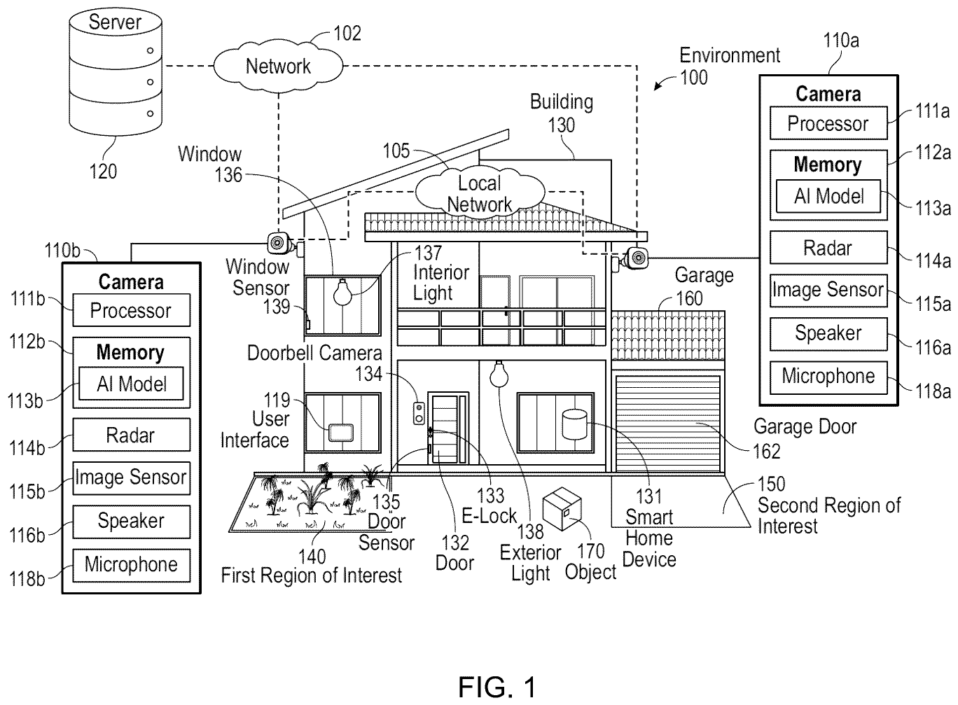

FIG. 1 illustrates an example environment 100, such as a residential property, in which the present systems and methods may be implemented. The environment 100 may include a site that can include one or more structures, any of which can be a structure or building 130, such as a home, office, warehouse, garage, and/or the like. The building 130 may include various entryways, such as one or more doors 132, one or more windows 136, and/or a garage 160 having a garage door 162. The environment 100 may include multiple sites. In some implementations, the environment 100 includes multiple sites, each corresponding to a different property and/or building. In an example, the environment 100 may be a cul-de-sac that includes multiple buildings 130.

The building 130 may include a security system 101 or one or more security devices that are configured to detect and mitigate crime and property theft and damage by alerting a trespasser or intruder that their presence is known while optionally alerting a monitoring service about detecting a trespasser or intruder (e.g., burglar). The security system 101 may include a variety of hardware components and software modules or programs configured to monitor and protect the environment 100 and one or more buildings 130 located thereat. In an embodiment, the security system 101 may include one or more sensors (e.g., cameras, microphones, vibration sensors, pressure sensors, motion detectors, proximity sensors (e.g., door or window sensors), range sensors, etc.), lights, speakers, and optionally one or more controllers (e.g., hub) at the building 130 in which the security system 101 is installed. In an embodiment, the cameras, sensors, lights, speakers, and/or other devices may be smart by including one or more processors therewith to be able to process sensed information (e.g., images, sounds, motion, etc.) so that decisions may be made by the processor(s) as to whether the captured information is associated with a security risk or otherwise.

The sensor(s) of the security system 101 may be used to detect a presence of a trespasser or intruder of the environment (e.g., outside, inside, above, or below the environment) such that the sensor(s) may automatically send a communication to the controller(s). The communication may occur whether or not the security system 101 is armed, but if armed, the controller(s) may initiate a different action than if not armed. For example, if the security system 101 is not armed when an entity is detected, then the controller(s) may simply record that a detection of an entity occurred without sending a communication to a monitoring service or taking local action (e.g., outputting an alert or other alarm audio signal) and optionally notify a user via a mobile app or other communication method of the detection of the entity. If the security system 101 is armed when a detection of an entity is made, then the controller(s) may initiate a disarm countdown timer (e.g., 60 seconds) to enable a user to disarm the security system 101 via a controller, mobile app, or otherwise, and, in response to the security system 101 not being disarmed (or being accepted by a user prior to completion of the countdown timer), communicate a notification including detection information (e.g., image, sensor type, sensor location, etc.) to a monitoring service (optionally after giving a user a chance to disarm the security system 101), which may, in turn, notify public authorities, such as police, to dispatch a unit to the environment 100, initiate an alarm (e.g., output an audible signal) local to the environment 100, communicate a message to a user via a mobile app or other communication (e.g., text message), or otherwise.

In the event that the security system 101 is armed and detects a trespasser or intruder, then the security system 101 may be configured to generate and communicate a message to a monitoring service of the security system 101. The monitoring service may be a third-party monitoring service (i.e., a service that is not the provider of the security system 101). The message may include a number of parameters, such as location of the environment 100, type of sensor, location of the sensor, image(s) if received, and any other information received with the message. It should be understood that the message may utilize any communications protocol for communicating information from the security service to the monitoring service. The message and data contained therein may be used to populate a template on a user interface of the monitoring service such that an operator at the monitoring service may view the data to assess a situation. In an embodiment, a user of the security system 101 may be able to provide additional information that may also be populated on the user interface for an operator in determining whether to contact the authorities to initiate a dispatch. The monitoring service may utilize a standard procedure in response to receiving the message in communicating with a user of the security service and/or dispatching the authorities.

A first camera 110a and a second camera 110b, referred to herein collectively as cameras 110, may be disposed at the environment 100, such as outside and/or inside the building 130. The cameras 110 may be attached to the building 130, such as at a front door of the building 130 or inside of a living room. The cameras 110 may communicate with each other over a local network 105. The cameras 110 may communicate with a server 120 over a network 102. The local network 105 and/or the network 102, in some implementations, may each include a digital communication network that transmits digital communications. The local network 105 and/or the network 102 may each include a wireless network, such as a wireless cellular network, a local wireless network, such as a Wi-Fi network, a Bluetooth® network, a near-field communication (“NFC”) network, an ad hoc network, and/or the like. The local network 105 and/or the network 102 may each include a wide area network (“WAN”), a storage area network (“SAN”), a local area network (“LAN”) (e.g., a home network), an optical fiber network, the internet, or other digital communication network. The local network 105 and/or the network 102 may each include two or more networks. The network 102 may include one or more servers, routers, switches, and/or other networking equipment. The local network 105 and/or the network 102 may also include one or more computer readable storage media, such as a hard disk drive, an optical drive, non-volatile memory, RAM, or the like.

The local network 105 and/or the network 102 may be a mobile telephone network. The local network 105 and/or the network 102 may employ a Wi-Fi network based on any one of the Institute of Electrical and Electronics Engineers (“IEEE”) 802.11 standards. The local network 105 and/or the network 102 may employ Bluetooth® connectivity and may include one or more Bluetooth connections. The local network 105 and/or the network 102 may employ Radio Frequency Identification (“RFID”) communications, including RFID standards established by the International Organization for Standardization (“ISO”), the International Electrotechnical Commission (“IEC”), the American Society for Testing and Materials® (ASTM®), the DASH7™ Alliance, and/or EPCGlobal™

In some implementations, the local network 105 and/or the network 102 may employ ZigBee® connectivity based on the IEEE 802 standard and may include one or more ZigBee connections. The local network 105 and/or the network 102 may include a ZigBee® bridge. In some implementations, the local network 105 and/or the network 102 employs Z-Wave® connectivity as designed by Sigma Designs® and may include one or more Z-Wave connections. The local network 105 and/or the network 102 may employ an ANT® and/or ANT+® connectivity as defined by Dynastream® Innovations Inc. of Cochrane, Canada and may include one or more ANT connections and/or ANT+ connections.

The first camera 110a may include an image sensor 115a, a processor 111a, a memory 112a, a radar sensor 114a, a speaker 116a, and a microphone 118a. The memory 112a may include computer-readable, non-transitory instructions which, when executed by the processor 111a, cause the processor 111a to perform methods and operations discussed herein. The processor 111a may include one or more processors. The second camera 110b may include an image sensor 115b, a processor 111b, a memory 112b, a radar sensor 114b, a speaker 116b, and a microphone 118b. The memory 112b may include computer-readable, non-transitory instructions which, when executed by the processor 111b, cause the processor to perform methods and operations discussed herein. The processor 111a may include one or more processors.

The memory 112a may include an AI model 113a. The AI model 113a may be applied to or otherwise process data from the camera 110a, the radar sensor 114a, and/or the microphone 118a to detect and/or identify one or more objects (e.g., people, animals, vehicles, shipping packages or other deliveries, or the like), one or more events (e.g., arrivals, departures, weather conditions, crimes, property damage, or the like), and/or other conditions. For example, the cameras 110 may determine a likelihood that an object 170, such as a package, vehicle, person, or animal, is within an area (e.g., a geographic area, a property, a room, a field of view of the first camera 110a, a field of view of the second camera 110b, a field of view of another sensor, or the like) based on data from the first camera 110a, the second camera 110b, and/or other sensors.

The memory 112b of the second camera 110b may include an AI model 113b. The AI model 113b may be similar to the AI model 113a. In some implementations, the AI model 113a and the AI model 113b have the same parameters. In some implementations, the AI model 113a and the AI model 113b are trained together using data from the cameras 110. In some implementations, the AI model 113a and the AI model 113b are initially the same, but are independently trained by the first camera 110a and the second camera 110b, respectively. For example, the first camera 110a may be focused on a porch and the second camera 110b may be focused on a driveway, causing data collected by the first camera 110a and the second camera 110b to be different, leading to different training inputs for the first AI model 113a and the second AI model 113b. In some implementations, the AI models 113 are trained using data from the server 120. In an example, the AI models 113 are trained using data collected from a plurality of cameras associated with a plurality of buildings. The cameras 110 may share data with the server 120 for training the AI models 113 and/or a plurality of other AI models. The AI models 113 may be trained using both data from the server 120 and data from their respective cameras.

The cameras 110, in some implementations, may determine a likelihood that the object 170 (e.g., a package) is within an area (e.g., a portion of a site or of the environment 100) based at least in part on audio data from microphones 118, using sound analytics and/or the AI models 113. In some implementations, the cameras 110 may determine a likelihood that the object 170 is within an area based at least in part on image data using image processing, image detection, and/or the AI models 113. The cameras 110 may determine a likelihood that an object is within an area based at least in part on depth data from the radar sensors 114, a direct or indirect time of flight sensor, an infrared sensor, a structured light sensor, or other sensor. For example, the cameras 110 may determine a location for an object, a speed of an object, a proximity of an object to another object and/or location, an interaction of an object (e.g., touching and/or approaching another object or location, touching a car/automobile or other vehicle, touching or opening a mailbox, leaving a package, leaving a car door open, leaving a car running, touching a package, picking up a package, or the like), and/or another determination based at least in part on depth data from the radar sensors 114.

The sensors, such as cameras 110, radar sensors 114, microphones 118, door sensors, window sensors, or other sensors, may be configured to detect a breach of security event for which the respective sensors are configured. For example, the microphones 118 may be configured to sense sounds, such as voices, broken glass, door knocking, or otherwise, and an audio processing system may be configured to process the audio so as to determine whether the captured audio signals are indicative of a trespasser or potential intruder of the environment 100 or building 130. Each of the signals generated or captured by the different sensors may be processed so as to determine whether the sounds are indicative of a security risk or not, and the determination may be time and/or situation dependent. For example, responses to sounds made when the security system 101 is armed may be different to responses to sounds when the security system 101 is unarmed.

A user interface 119 may be installed or otherwise located at the building 130. The user interface 119 may be part of or executed by a device, such as a mobile phone, a tablet, a laptop, wall panel, or other device. The user interface 119 may connect to the cameras 110 via the network 102 or the local network 105. The user interface 119 may allow a user to access sensor data of the cameras 110. In an example, the user interface 119 may allow the user to view a field of view of the image sensors 115 and hear audio data from the microphones 118. In an example, the user interface may allow the user to view a representation, such as a point cloud, of radar data from the radar sensors 114.

The user interface 119 may allow a user to provide input to the cameras 110. In an example, the user interface 119 may allow a user to speak or otherwise provide sounds using the speakers 116.

In some implementations, the cameras 110 may receive additional data from one or more additional sensors, such as a door sensor 135 of the door 132, an electronic lock 133 of the door 132, a doorbell camera 134, and/or a window sensor 139 of the window 136. The door sensor 135, the electronic lock 133, the doorbell camera 134 and/or the window sensor 139 may be connected to the local network 105 and/or the network 102. The cameras 110 may receive the additional data from the door sensor 135, the electronic lock 133, the doorbell camera 134 and/or the window sensor 139 from the server 120.

In some implementations, the cameras 110 may determine separate and/or independent likelihoods that an object is within an area based on data from different sensors (e.g., processing data separately, using separate machine learning and/or other artificial intelligence, using separate metrics, or the like). The cameras 110 may combine data, likelihoods, determinations, or the like from multiple sensors such as image sensors 115, the radar sensors 114, and/or the microphones 118 into a single determination of whether an object is within an area (e.g., in order to perform an action relative to the object 170 within the area. For example, the cameras 110 and/or each of the cameras 110 may use a voting algorithm and determine that the object 170 is present within an area in response to a majority of sensors of the cameras and/or of each of the cameras determining that the object 170 is present within the area. In some implementations, the cameras 110 may determine that the object 170 is present within an area in response to all sensors determining that the object 170 is present within the area (e.g., a more conservative and/or less aggressive determination than a voting algorithm). In some implementations, the cameras 110 may determine that the object 170 is present within an area in response to at least one sensor determining that the object 170 is present within the area (e.g., a less conservative and/or more aggressive determination than a voting algorithm).

The cameras 110, in some implementations, may combine confidence metrics indicating likelihoods that the object 170 is within an area from multiple sensors of the cameras 110 and/or additional sensors (e.g., averaging confidence metrics, selecting a median confidence metric, or the like) in order to determine whether the combination indicates a presence of the object 170 within the area. In some embodiments, the cameras 110 are configured to correlate and/or analyze data from multiple sensors together. For example, the cameras 110 may detect a person or other object in a specific area and/or field of view of the image sensors 115 and may confirm a presence of the person or other object using data from additional sensors of the cameras 110 such as the radar sensors 114 and/or the microphones 118, confirming a sound made by the person or other object, a distance and/or speed of the person or other object, or the like. The cameras 110, in some implementations, may detect the object 170 with one sensor and identify and/or confirm an identity of the object 170 using a different sensor. In an example, the cameras detect the object 170 using the image sensor 115a of the first camera 110a and verifies the object 170 using the radar sensor 114b of the second camera 110b. In this manner, in some implementations, the cameras 110 may detect and/or identify the object 170 more accurately using multiple sensors than may be possible using data from a single sensor.

The cameras 110, in some implementations, in response to determining that a combination of data and/or determinations from the multiple sensors indicates a presence of the object 170 within an area, may perform initiate, or otherwise coordinate one or more actions relative to the object 170 within the area. For example, the cameras 110 may perform an action including emitting one or more sounds from the speakers 116, turning on a light, turning off a light, directing a lighting element toward the object 170, opening or closing the garage door 162, turning a sprinkler on or off, turning a television or other smart device or appliance on or off, activating a smart vacuum cleaner, activating a smart lawnmower, and/or performing another action based on a detected object, based on a determined identity of a detected object, or the like. In an example, the cameras 110 may actuate an interior light 137 of the building 130 and/or an exterior light 138 of the building 130. The interior light 137 and/or the exterior light 138 may be connected to the local network 105 and/or the network 102.

In some embodiments, the security system 101 and/or security device may perform initiate, or otherwise coordinate an action selected to deter a detected person (e.g., to deter the person from the area and/or property, to deter the person from damaging property and/or committing a crime, or the like), to deter an animal, or the like. For example, based on a setting and/or mode, in response to failing to identify an identity of a person (e.g., an unknown person, an identity failing to match a profile of an occupant or known user in a library, based on facial recognition, based on bio-identification, or the like), and/or in response to determining a person is engaged in suspicious behavior and/or has performed a suspicious action, or the like, the cameras 110 may perform, initiate, or otherwise coordinate an action to deter the detected person. In some implementations, the cameras 110 may determine that a combination of data and/or determinations from multiple sensors indicates that the detected human is, has, intends to, and/or may otherwise perform one or more suspicious acts, from a set of predefined suspicious acts or the like, such as crawling on the ground, creeping, running away, picking up a package, touching an automobile and/or other vehicle, opening a door of an automobile and/or other vehicle, looking into a window of an automobile and/or other vehicle, opening a mailbox, opening a door, opening a window, throwing an object, or the like.

In some implementations, the cameras 110 may monitor one or more objects based on a combination of data and/or determinations from the multiple sensors. For example, in some embodiments, the cameras 110 may detect and/or determine that a detected human has picked up the object 170 (e.g., a package, a bicycle, a mobile phone or other electronic device, or the like) and is walking or otherwise moving away from the home or other building 130. In a further embodiment, the cameras 110 may monitor a vehicle, such as an automobile, a boat, a bicycle, a motorcycle, an offroad and/or utility vehicle, a recreational vehicle, or the like. The cameras 110, in various embodiments, may determine if a vehicle has been left running, if a door has been left open, when a vehicle arrives and/or leaves, or the like.

The environment 100 may include one or more regions of interest, which each may be a given area within the environment. A region of interest may include the entire environment 100, an entire site within the environment, or an area within the environment. A region of interest may be within a single site or multiple sites. A region of interest may be inside of another region of interest. In an example, a property-scale region of interest which encompasses an entire property within the environment 100 may include multiple additional regions of interest within the property.

The environment 100 may include a first region of interest 140 and/or a second region of interest 150. The first region of interest 140 and the second region of interest 150 may be determined by the AI models 113, fields of view of the image sensors 115 of the cameras 110, fields of view of the radar sensors 114, and/or user input received via the user interface 119. In an example, the first region of interest 140 includes a garden or other landscaping of the building 130 and the second region of interest 150 includes a driveway of the building 130. In some implementations, the first region of interest 140 may be determined by user input received via the user interface 119 indicating that the garden should be a region of interest and the AI models 113 determining where in the fields of view of the sensors of the cameras 110 the garden is located. In some implementations, the first region of interest 140 may be determined by user input selecting, within the fields of view of the sensors of the cameras 110 on the user interface 119, where the garden is located. Similarly, the second region of interest 150 may be determined by user input indicating, on the user interface 119, that the driveway should be a region of interest and the AI models 113 determining where in the fields of view of the sensors of the cameras 110 the driveway is located. In some implementations, the second region of interest 150 may be determined by user input selecting, on the user interface 119, within the fields of view of the sensors of the cameras 110, where the driveway is located.

In response to determining that a combination of data and/or determinations from the multiple sensors indicates that a detected human (e.g., an entity) is, has, intends to, and/or may otherwise perform one or more suspicious acts, is unknown/unrecognized, has entered a restricted area/zone such as the first region of interest 140 or the second region of interest 150, the security system 101 and/or security devices may expedite a deter action, reduce a waiting/monitoring period after detecting the human and before performing a deter action, or the like. In response to determining that a combination of data and/or determinations from the multiple sensors indicates that a detected human is continuing and/or persisting performance of one or more suspicious acts, the cameras 110 may escalate one or more deter actions, perform one or more additional deter actions (e.g., a more serious deter action), or the like. For example, the cameras 110 may play an escalated and/or more serious sound such as a siren, yelling, or the like; may turn on a spotlight, strobe light, or the like; and/or may perform, initiate, or otherwise coordinate another escalated and/or more serious action. In some embodiments, the cameras 110 may enter a different state (e.g., an armed mode, a security mode, an away mode, or the like) in response to detecting a human in a predefined restricted area/zone or other region of interest, or the like (e.g., passing through a gate and/or door, entering an area/zone previously identified by an authorized user as restricted, entering an area/zone not frequently entered such as a flowerbed, shed or other storage area, or the like).

In a further embodiment, the cameras 110 may perform, initiate, or otherwise coordinate, a welcoming action and/or another predefined action in response to recognizing a known human (e.g., an identity matching a profile of an occupant or known user in a library, based on facial recognition, based on bio-identification, or the like) such as executing a configurable scene for a user, activating lighting, playing music, opening or closing a window covering, turning a fan on or off, locking or unlocking a door 132, lighting a fireplace, powering an electrical outlet, turning on or play a predefined channel or video or music on a television or other device, starting or stopping a kitchen appliance, starting or stopping a sprinkler system, opening or closing a garage door 162, adjusting a temperature or other function of a thermostat or furnace or air conditioning unit, or the like. In response to detecting a presence of a known human, one or more safe behaviors and/or conditions, or the like, in some embodiments, the cameras 110 may extend, increase, pause, toll, and/or otherwise adjust a waiting/monitoring period after detecting a human, before performing a deter action, or the like.

In some implementations, the cameras 110 may receive a notification from a user's smart phone that the user is within a predefined proximity or distance from the home, e.g., on their way home from work. Accordingly, the cameras 110 may activate a predefined or learned comfort setting for the home, including setting a thermostat at a certain temperature, turning on certain lights inside the home, turning on certain lights on the exterior of the home, turning on the television, turning a water heater on, and/or the like.

The cameras 110, in some implementations, may be configured to detect one or more health events based on data from one or more sensors. For example, the cameras 110 may use data from the radar sensors 114 to determine a heartrate, a breathing pattern, or the like and/or to detect a sudden loss of a heartbeat, breathing, or other change in a life sign. The cameras 110 may detect that a human has fallen and/or that another accident has occurred.

In some embodiments, the security system 101 and/or one or more security devices may include one or more speakers 116. The speaker(s) 116 may be independent from other devices or integrated therein. For example, the camera(s) may include one or more speakers 116 (e.g. speakers 116a, 116b) that enable sound to be output therefrom. In an embodiment, a controller or other device may include a speaker from which sound (e.g., alarm sound, tones, verbal audio, and/or otherwise) may be output. The controller may be configured to cause audio sounds (e.g., verbal commands, dog barks, alarm sounds, etc.) to play and/or otherwise emit those audio from the speaker(s) 116 located at the building 130. In an embodiment, one or more sounds may be output in response to detecting the presence of a human within an area. For example, the controller may cause the speaker may play one or more sounds selected to deter a detected person from an area around a building 130, environment 100, and/or object. The speaker(s) 116, in some implementations, may vary sounds over time, dynamically layer and/or overlap sounds, and/or generate unique sounds, to preserve a deterrent effect of the sounds over time and/or to avoid, limit, or even prevent those being deterred from becoming accustomed to the same sounds used over and over.

The security system 101, one or more security devices, and/or the speakers 116, in some implementations, may be configured to store and/or has access to a library comprising a plurality of different sounds and/or a set of dynamically generated sounds so that the controller (e.g., user interface 119) may vary the different sounds over time, thereby not using the same sound too often. In some embodiments, varying and/or layering sounds allows a deter sound to be more realistic and/or less predictable.

One or more of the sounds may be selected to give a perception of human presence in the environment 100 or building 130, a perception of a human talking over an electronic speaker 116 in real-time, or the like which may be effective at preventing crime and/or property damage. For example, a library and/or other set of sounds may include audio recordings and/or dynamically generated sounds of one or more, male and/or female voices saying different phrases, such as for example, a female saying “hello?,” a female and male together saying “can we help you?,” a male with a gruff voice saying, “get off my property” and then a female saying “what's going on?,” a female with a country accent saying “hello there,” a dog barking, a teenager saying “don't you know you're on camera?,” and/or a man shouting “hey!” or “hey you!,” or the like.

In some implementations, the security system 101, one or more security devices, and/or the speaker 116 may dynamically generate one or more sounds (e.g., using machine learning and/or other artificial intelligence, or the like) with one or more attributes that vary from a previously played sound. For example, the security system, one or more security devices, and/or the speaker 116 may generate sounds with different verbal tones, verbal emotions, verbal emphases, verbal pitches, verbal cadences, verbal accents, or the like so that the sounds are said in different ways, even if they include some or all of the same words. In some embodiments, the security system 101, one or more security devices, the speaker 116 and/or a remote computing device (e.g., a computer, the server 120, etc.) may train machine learning on reactions of previously detected humans in other areas to different sounds and/or sound combinations (e.g., improving sound selection and/or generation over time).

The security system 101, one or more security devices, and/or the speaker 116 may combine and/or layer these sounds (e.g., primary sounds), with one or more secondary, tertiary, and/or other background sounds, which may comprise background noises selected to give an appearance that a primary sound is a person speaking in real time, or the like. For example, a secondary, tertiary, and/or other background sound may include sounds of a kitchen, of tools being used, of someone working in a garage, of children playing, of a television being on, of music playing, of a dog barking, or the like. The security system 101, one or more security devices, and/or the speaker 116, in some embodiments, may be configured to combine and/or layer one or more tertiary sounds with primary and/or secondary sounds for more variety, or the like. For example, a first sound (e.g., a primary sound) may comprise a verbal language message and a second sound (e.g., a secondary and/or tertiary sound) may comprise a background noise for the verbal language message (e.g., selected to provide a real-time temporal impression for the verbal language message of the first sound, or the like).

In this manner, in various embodiments, the security system 101, one or more security devices, and/or the speaker 116 may intelligently track which sounds and/or combinations of sounds have been played, and in response to detecting the presence of a human, may select a first sound to play that is different than a previously played sound, may select a second sound to play that is different than the first sound, and may play the first and second sounds at least partially simultaneously and/or overlapping. For example, the security system 101, one or more security devices, and/or the speaker 116 may play a primary sound layered and/or overlapping with one or more secondary, tertiary, and/or background sounds, varying the sounds and/or the combination from one or more previously played sounds and/or combinations, or the like.

The security system 101, one or more security devices, and/or the speaker 116, in some embodiments, may select and/or customize an action based at least partially on one or more characteristics of a detected object. For example, the cameras 110 may determine one or more characteristics of the object 170 based on audio data, image data, depth data, and/or other data from a sensor. For example, the cameras 110 may determine a characteristic such as a type or color of an article of clothing being worn by a person, a physical characteristic of a person, an item being held by a person, or the like. The cameras 110 may customize an action based on a determined characteristic, such as by including a description of the characteristic in an emitted sound (e.g., “hey you in the blue coat!”, “you with the umbrella!”, or another description), or the like.

The security system 101, one or more security devices, and/or the speaker 116, in some implementations, may escalate and/or otherwise adjust an action over time and/or may perform a subsequent action in response to determining (e.g., based on data and/or determinations from one or more sensors, from the multiple sensors, or the like) that the object 170 (e.g., a human, an animal, vehicle, drone, etc.) remains in an area after performing a first action (e.g., after expiration of a timer, or the like). For example, the security system 101, one or more security devices, and/or the speaker 116 may increase a volume of a sound, emit a louder and/or more aggressive sound (e.g., a siren, a warning message, an angry or yelling voice, or the like), increase a brightness of a light, introduce a strobe pattern to a light, and/or otherwise escalate an action and/or subsequent action. In some implementations, the security system 101, one or more security devices, and/or the speaker 116 may perform a subsequent action (e.g., an escalated and/or adjusted action) relative to the object 170 in response to determining that movement of the object 170 satisfies a movement threshold based on subsequent depth data from the radar sensors 114 (e.g., subsequent depth data indicating the object 170 is moving and/or has moved at least a movement threshold amount closer to the radar sensors 114, closer to the building 130, closer to another identified and/or predefined object, or the like).

In some implementations, the cameras 110 and/or the server 120 (or other device), may include image processing capabilities and/or radar data processing capabilities for analyzing images, videos, and/or radar data that are captured with the cameras 110. The image/radar processing capabilities may include object detection, facial recognition, gait detection, and/or the like. For example, the controller 106 may analyze or process images and/or radar data to determine that a package is being delivered at the front door/porch. In other examples, the cameras 110 may analyze or process images and/or radar data to detect a child walking within a proximity of a pool, to detect a person within a proximity of a vehicle, to detect a mail delivery person, to detect animals, and/or the like. In some implementations, the cameras 110 may utilize the AI models 113 for processing and analyzing image and/or radar data.

In some implementations, the security system 101, one or more security devices, and/or the speaker 116 are connected to various IoT devices. As used herein, an IoT device may be a device that includes computing hardware to connect to a data network and to communicate with other devices to exchange information. In such an embodiment, the cameras 110 may be configured to connect to, control (e.g., send instructions or commands), and/or share information with different IoT devices. Examples of IoT devices may include home appliances (e.g. stoves, dishwashers, washing machines, dryers, refrigerators, microwaves, ovens, coffee makers), vacuums, garage door openers, thermostats, HVAC systems, irrigation/sprinkler controller, television, set-top boxes, grills/barbeques, humidifiers, air purifiers, sound systems, phone systems, smart cars, cameras, projectors, and/or the like. In some implementations, the cameras 110 may poll, request, receive, or the like information from the IoT devices (e.g., status information, health information, power information, and/or the like) and present the information on a display and/or via a mobile application.

The IoT devices may include a smart home device 131. The smart home device 131 may be connected to the IoT devices. The smart home device 131 may receive information from the IoT devices, configure the IoT devices, and/or control the IoT devices. In some implementations, the smart home device 131 provides the cameras 110 with a connection to the IoT devices. In some implementations, the cameras 110 provide the smart home device 131 with a connection to the IoT devices. The smart home device 131 may be an AMAZON ALEXA device, an AMAZON ECHO, A GOOGLE NEST device, a GOOGLE HOME device, or other smart home hub or device. In some implementations, the smart home device 131 may receive commands, such as voice commands, and relay the commands to the cameras 110. In some implementations, the cameras 110 may cause the smart home device 131 to emit sound and/or light, speak words, or otherwise notify a user of one or more conditions via the user interface 119.

In some implementations, the IoT devices include various lighting components including the interior light 137, the exterior light 138, the smart home device 131, other smart light fixtures or bulbs, smart switches, and/or smart outlets. For example, the cameras 110 may be communicatively connected to the interior light 137 and/or the exterior light 138 to turn them on/off, change their settings (e.g., set timers, adjust brightness/dimmer settings, and/or adjust color settings).

In some implementations, the IoT devices include one or more speakers within the building. The speakers may be stand-alone devices such as speakers that are part of a sound system, e.g., a home theatre system, a doorbell chime, a Bluetooth speaker, and/or the like. In some implementations, the one or more speakers may be integrated with other devices such as televisions, lighting components, camera devices (e.g., security cameras that are configured to generate an audible noise or alert), and/or the like. In some implementations, the speakers may be integrated in the smart home device 131.

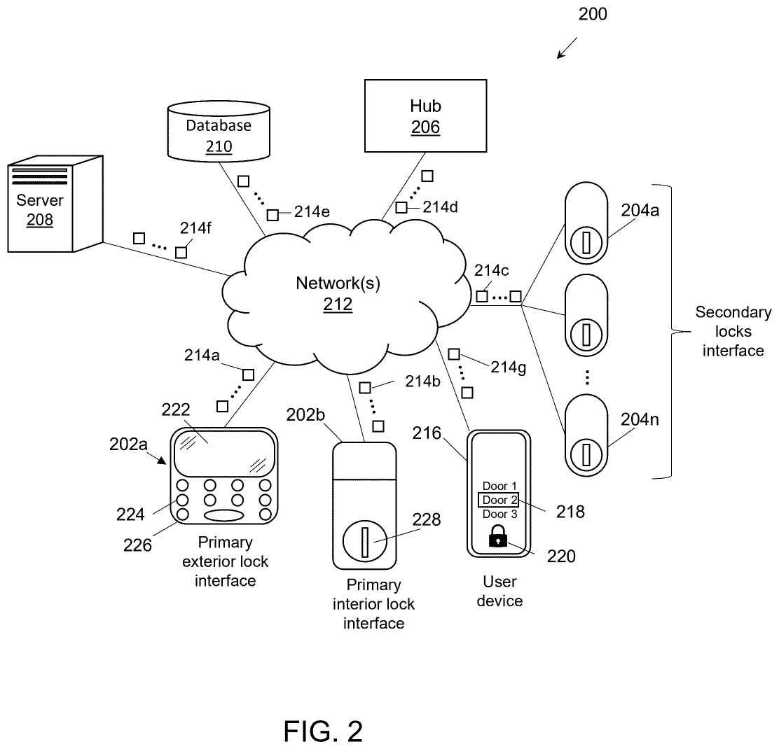

Turning now to FIG. 2, a block diagram of an illustrative system 200, including multiple communicatively coupled smart locks for securing an enclosed space (e.g., a building) is shown, according to an embodiment. The system 200 may be located partially or entirely within the enclosed space. The enclosed space may be, for example, any building, edifice, or enclosure including one or more walls and one or more entrances. In the present disclosure, the building may include, but is not limited to, a home, office, store, business, courtyard, etc. The system 200 within and engaged to the building may include a primary exterior lock interface 202a, a primary interior lock interface 202b, one or more secondary lock interfaces 204a-204n (collectively 204), and a hub 206 located internal and/or external from the space. The system 200 may further include a server 208, a database 210, one or more networks 212 (e.g., a local network may be part of the system 200 provided by the security system), and/or a user device 216. The various devices and components of the system 200 may communicate with one another via the one or more networks 212. The system 200 may be used to access, view, control, and/or adjust one or more locks of the doors that are engaged to the primary interior lock interface 202b, and the secondary lock interfaces 204 from a single location exterior to the building (e.g., the primary exterior lock interface 202a). By way of example, and for ease of description, the single location exterior to the building may be a primary door, which may be a front door, a gate, or any other entrance of the enclosed space. According to some embodiments, the primary door may be a primary exit/entrance through which a user of the system 200 primarily exits/enters the building. In some embodiments, the primary door may be a garage door. In addition to the primary door, the enclosed space may include one or more secondary doors. Secondary doors may be entrances or exits from the building that do not serve as the user's primary means of entering/exiting the building. Secondary doors may include a side door, a side gate, a back door, a garage door, etc. Though the term “door” is used in various terms of the present disclosure, it should be understood that the any mechanism or means for entering/exiting the building may be encompassed in the term “door.” For example, “door” may encompass sliding doors, rotating doors, windows, gates, overhead doors, barn doors, etc.

For ease of description and understanding, FIG. 2 depicts the system 200 as having one or a small number of each component. Embodiments may, however, include additional or alternative components, or omit certain components, from those of FIG. 2 and still fall within the scope of this disclosure. As an example, it may be common for embodiments to include multiple servers 208 and/or multiple databases 210 that are communicably coupled to or operated by the server 208 and the primary exterior lock interface 202a through the network 212. Embodiments may include or otherwise implement any number of devices capable of performing the various features and tasks described herein. For instance, FIG. 2 depicts the database 210 as hosted as or operated as a distinct computing device from the server 208, though, in some embodiments, the server 208 may include an integrated database 210 hosted by the server 208.

The system 200 may include or utilize one or more networks 212, which may include any number of internal networks, (e.g., LANs) external networks (e.g., WANs), private networks (e.g., intranets, VPNs), and public networks (e.g., Internet). The network(s) 212 may include various hardware and software components for hosting and conducting communications amongst the components of the system 200. Moreover, non-limiting examples of such internal or external networks 212 may include a Local Area Network (LAN), Wireless Local Area Network (WLAN), Metropolitan Area Network (MAN), Wide Area Network (WAN), and the Internet. The communication over the networks 212 may be performed in accordance with various communication protocols, such as Transmission Control Protocol and Internet Protocol (TCP/IP), User Datagram Protocol (UDP), and IEEE communication protocols, among others. Additional, and/or alternative communication protocols that may be used by the network(s) 212 may include Wi-Fi, Bluetooth, Zigbee, Z-Wave, Thread, Insteon, LoRaWAN, KNK, DALI, and/or UPnP.

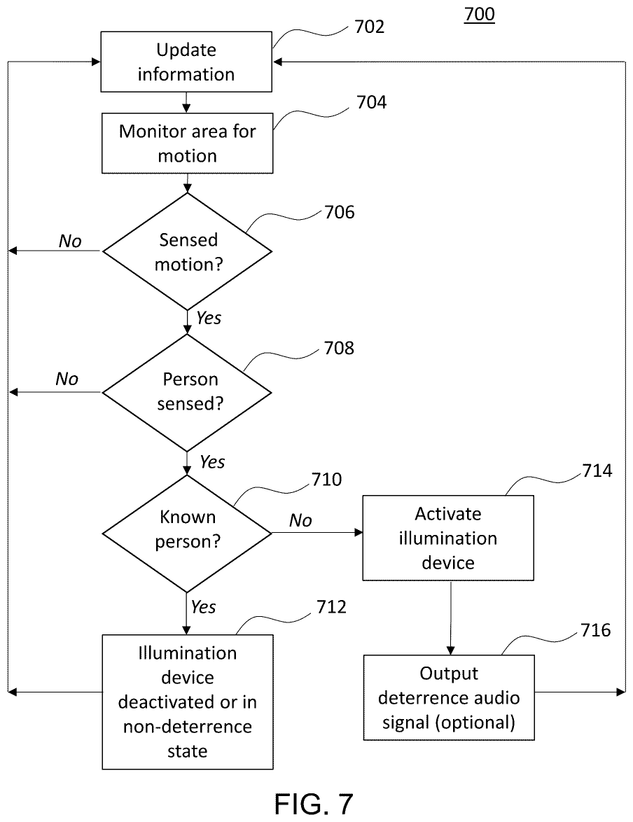

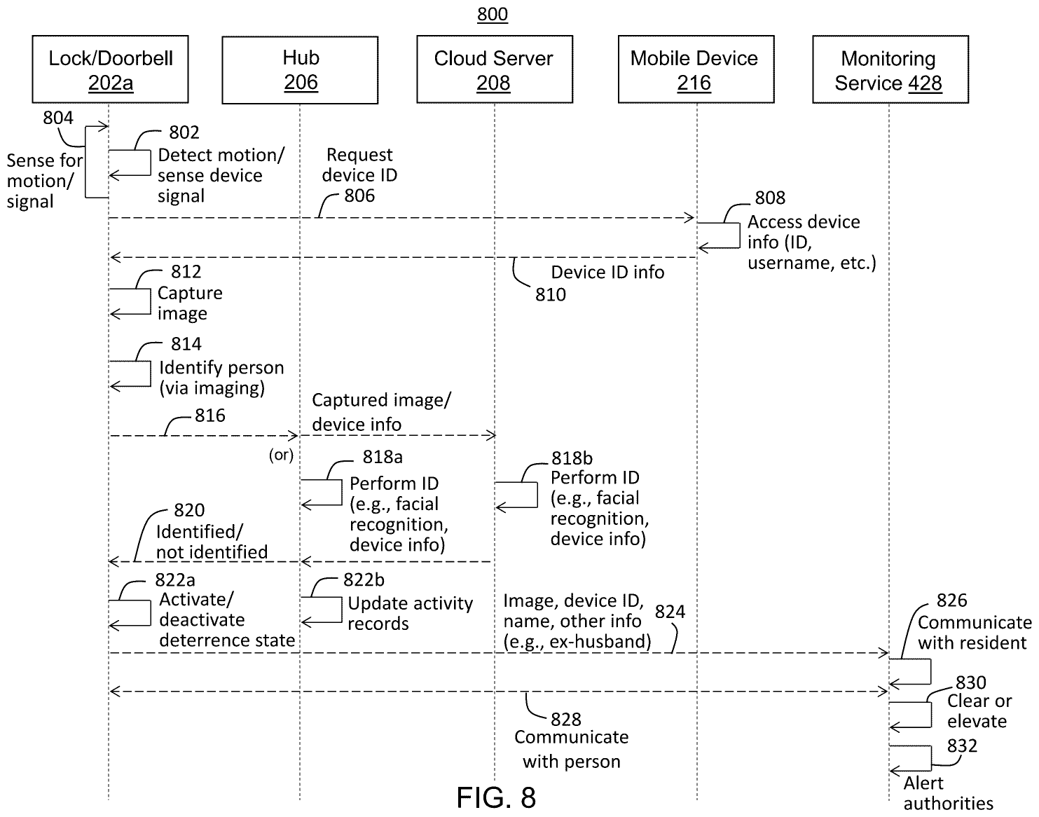

The server 208 may include one or more processors that execute one or more software programs to perform various processes (e.g., the process 700 of FIG. 7 and/or the process 800 of FIG. 8). The server 208 may include processor(s) and non-transitory, computer readable medium including instructions, which, when executed by the processor(s), cause the processor to perform methods disclosed herein. The processor(s) may include any number of physical, hardware processor. Although FIG. 2 shows only a single server 208, the server 208 may include any number of computing devices. In some cases, the computing devices of the server 208 may perform all or portions of the processes described herein to support the system 200. The server 208 may include computing devices (e.g., processors) operating in a distributed or cloud computing configuration and/or in a virtual machine configuration. It should also be appreciated that, in some embodiments, one or more functions of the server 208 may be partly or entirely performed by the primary exterior lock interface 202a or any other component (e.g., the hub 206).

The hub 206 may be configured to perform functions similar to, or the same as, the controller 106 of FIG. 1, as previously described. The hub 206 may be communicatively coupled with the various components of the system 200 and/or other smart devices of the building directly or indirectly (e.g., through the network(s) 212, as shown in FIG. 2). By way of example, the hub 206 may receive control signals from, and transmit the control signals to, the primary exterior lock interface 202a, the primary interior lock interface 202b, and/or the secondary lock interfaces 204. The hub 206 may be configured to receive various communication protocol signals and translate the various communication protocol signals into control signals to control the various components of the system 200.

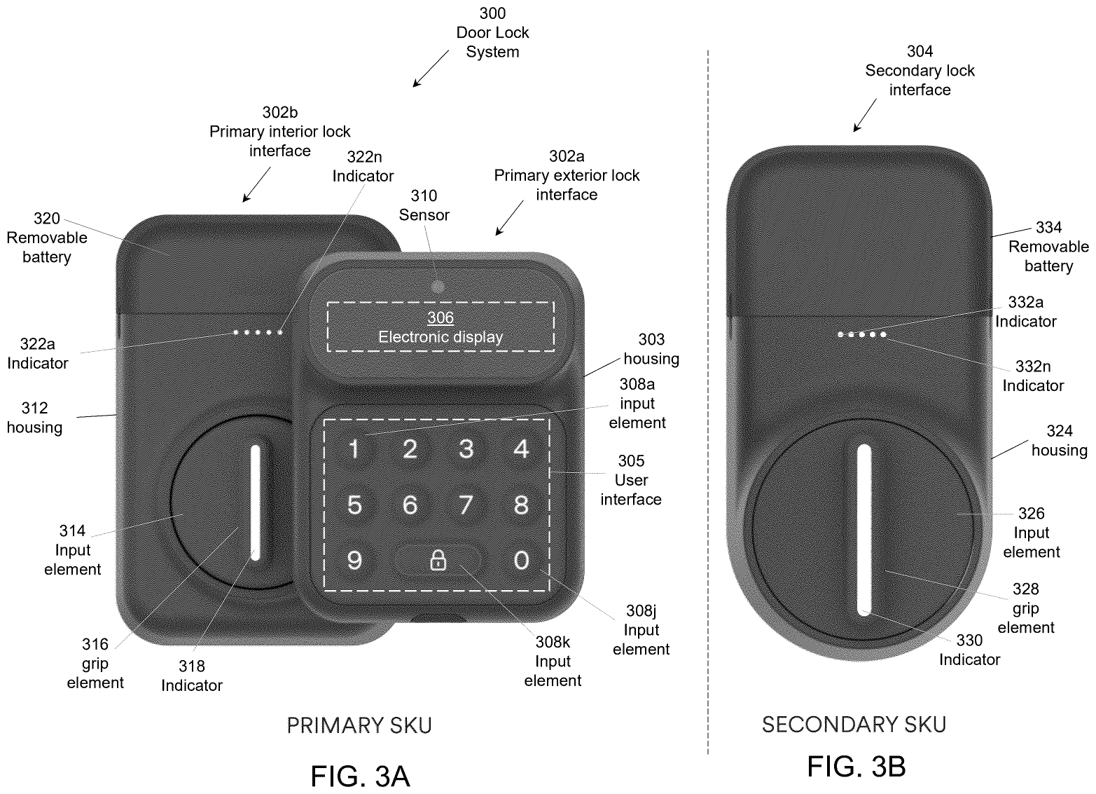

The primary exterior lock interface 202a (e.g., a controller) may be any type of electronic device including hardware components (e.g., one or more processors, non-transitory memory, user interface, housing, etc.) and software components capable of performing the various processes and tasks described herein. The primary exterior lock interface 202a may include a user input device 224 for receiving instructions and interactions from the user. The primary exterior lock interface 202a may include an electronic display 222 for presenting information to the user. By way of example, the primary exterior lock interface 202a may be distinct from the hub 206. Alternatively, the primary exterior lock interface 202a may perform the same or the similar functions as the hub 206. The hub 206 may be configured to perform the same or similar functions as the controller 106 of FIG. 1. Non-limiting examples of the primary exterior lock interface 202a include smart home devices (e.g., smart locks), personal computers (e.g., laptop computers, desktop computers), server computers, mobile devices (e.g., smartphones, tablets), VR devices, and gaming consoles, smart watches, among other types of electronic devices. In an illustrative embodiment, the primary exterior lock interface 202a is configured to operate in conjunction with the primary interior lock interface 202b door lock so as to function as a smart lock for the primary door of the enclosed space. As will be described in greater detail in FIG. 3A, the primary exterior lock interface 202a may include an electronic display 222, a user input device 224 (e.g., keypad), a communication module (not shown), and a physical housing 226.

When installed, the primary exterior lock interface 202a may be mounted (e.g., located, installed, placed, attached, integrated) on the exterior of the primary door (e.g., positioned near or at a handle, lock, and/or doorknob). Alternatively, the primary exterior lock interface 202a may be mounted on a wall of the enclosed space. In general, the primary exterior lock interface 202a may be positioned anywhere that enables communications with the primary interior lock interface 202b wirelessly or via a wired connection.

The primary exterior lock interface 202a may include one or more computing devices that execute one or more software programs to perform various processes (e.g., the process 700 of FIG. 7 and/or the process 800 of FIG. 8). The primary exterior lock interface 202a may include a processor and non-transitory, computer-readable medium or memory including instructions, which, when executed by the processor, causes the processor to perform methods disclosed herein. The processor may include any number of physical, hardware processors that execute software to perform the functions described herein.

The primary interior lock interface 202b may be (or include) any type of electronic device comprising hardware components (e.g., one or more processors, non-transitory storage, etc.) and software executable by one or more processors capable of performing the various processes and tasks described herein. Non-limiting examples of the computing devices of the primary interior lock interface 202b include smart home devices (e.g., smart locks), personal computers (e.g., laptop computers, desktop computers), server computers, mobile devices (e.g., smartphones, tablets), VR devices, and gaming consoles, smart watches, among other types of electronic devices. The primary interior lock interface 202b may include a grip element 228 for receiving instructions and/or indications from the user. In an illustrative embodiment, the primary interior lock interface 202b is considered an interior smart lock for the primary door, where the interior smart lock interface 202b is physically configured to engage a feature (e.g., thumb turn) of a door lock so as to electronically lock and unlock the door lock (e.g., deadbolts). As will be described in greater detail in FIG. 3A, the primary interior lock interface 202b may include one or more indicators, a user input, a communication module, a lock engagement member, and a physical housing. The primary interior lock interface 202b may be mounted (e.g., located, installed, placed) on an interior of the primary door(s) and physically engage a portion of the door lock so as to control locking and unlocking the door lock, as further described herein.

The primary interior lock interface 202b may include one or more processors configured to execute one or more software programs to perform various processes (e.g., the process 700 of FIG. 7 and/or the process 800 of FIG. 8). The primary interior lock interface 202b may include a processor and non-transitory, computer-readable medium including instructions, which, when executed by the processor, cause the processor to perform methods disclosed herein (e.g., causing a locking mechanism to transition from a locked state to an unlocked state, and vice versa). The processor may include any number and type of processors. In some cases, the computing devices of the primary interior lock interface 202b may perform at least a portion of the processes of the hub 206 and/or the primary exterior lock interface 202a. The primary interior lock interface 202b may also include various hardware mechanisms (e.g., actuators) to lock or unlock a mechanical, electromechanical, electromagnetic, or other type of lock of the primary door, as shown in greater detail in FIG. 3A. The primary exterior lock interface 202a and primary interior lock interface 202b may be in communication with one another such that a user who enters a command (e.g., unlock) into the interface 202a causes the interface 202b to perform an action (e.g., rotate a thumb turn of a deadbolt lock).

In addition, the primary interior lock interface 202b may include one or more indicators (e.g., speakers, lights, displays, haptic machines, etc.) to indicate a state of one or more locks (e.g., the primary interior lock interface 202b and/or the secondary lock interfaces 204a-204n). By way of example, the primary interior lock interface 202b may include multiple illumination devices (e.g., LEDs) on or in a housing of the primary interior lock interface 202b that illuminate respective indicators (e.g., numerals 1-6, spots, words, etc.) that assist a user with knowing which doors and/or windows are locked. More specifically, each illumination device may correspond to a smart lock (e.g., door lock configured with primary or secondary lock interfaces 202 or 204) of the building. In an embodiment, each illumination device may have two states, a first state (e.g., OFF) associated with a locked state of the smart lock and the second state (e.g., ON) associated with an unlocked state of the smart lock. In this way, the user may quickly identify, based on the state of the illumination devices that are illuminating or not illuminating the indicators, the state of each smart lock of the building from a central location at a glance of the lock interfaces 202 and 204. For example, primary interior lock interface 202b may receive an indication of the state of each of the smart lock interfaces 202 and 204 of the system 200 from each of the lock interfaces 202 and 204 directly or indirectly, from the primary exterior lock interface 202a, the hub 206, and/or the server 208.

The primary interior lock interface 202b may include one or more sensors (e.g., cameras, proximity sensors, radar, sonar, infrared, etc.) to determine a presence of the user. Responsive to receiving an indication, from the sensor(s), of the presence of the user, the indicators may display an indication of the sensed presence of the user. In certain embodiments, the primary exterior lock interface 202a also includes indicators that may function substantially in the same manner as the indicators of the primary interior lock interface 202b. Likewise, the secondary lock interfaces 204a-204n may also include indicators that function substantially in the same manner as the indicators of the primary interior lock interface 202b.

The primary interior lock interface 202b may include a specialized and/or configurable physical housing to position over a manual thumb turn of a deadbolt of a door. The primary interior lock interface 202b may include one or more actuators that are electronically controlled to automatically switch states (e.g., lock or unlock) in response to received one or more control signals (e.g., from the primary exterior lock interface 202a, the hub 206, and/or the primary interior lock interface 202b). For example, the primary interior lock interface 202b may receive a control signal from the primary exterior lock interface 202a to transition a state of the primary door from an unlocked state to a locked state. Upon receiving the control signal at the primary interior lock interface 202b, the primary interior lock interface 202b actuates an actuator of the primary interior lock interface 202b to rotate the manual thumb turn (or the deadbolt directly) of the primary door into a locked position. In an alternative embodiment, the primary exterior lock interface 202a may receive the control signal or generate the control signal in response to a user interfacing directly with the primary exterior lock interface 202a and communicate the control signal to the primary interface lock interface 202b (and/or one or more secondary lock interface 204) to cause the state of associated locks to change.

In some embodiments, the primary interior lock interface 202b may be configured to actuate the lock of a door in an alternative manner engaging a manual thumb turn of the lock (e.g., deadbolt) of the primary door. In such embodiments, the primary interior lock interface 202b may include an integrated deadbolt and/or be integrated into or on the primary interior door. The integrated deadbolt may be physically and/or mechanically coupled to one or more actuators of the primary interior lock interface 202b, and function to adjust a position of the integrated deadbolt from a locked or unlock position or vice versa. In integrated deadbolt embodiments, the primary interior lock interface 202b may function in substantially the same manner as the embodiments in which the primary interior lock interface 202b fits over the manual thumb turn. Upon the primary interior lock interface 202b transitioning from an unlocked state to a locked state or a locked state to an unlocked state, an indicator corresponding to the primary interior lock interface 202b may transition states (e.g., unlit to lit, lit to unlit, change colors, etc.), as well. Likewise, an indicator on each additional smart lock interface (for example secondary lock interface 204a and/or the primary exterior lock interface 202a) adjust states as well. Upon the primary interior lock interface 202b changing lock states, especially if manually locked or unlocked, the primary interior lock interface 202b may transmit a signal indicative of the change of lock state. The additional smart locks may receive the signal transmitted from the primary interior lock interface 202b indicating the change in lock state, and in response to receiving the transmitted signal indicating the change in lock state, the secondary smart lock interfaces 204 may change the state of the indicator corresponding to the primary interior lock interface 202b. This method (e.g., changing lock states, transmitting changed locked state, updating corresponding lock status indicator) may be executed by any of the smart locks of the system 200.

By way of example, the primary exterior lock interface 202a may function as a control point to adjust the lock state of some or all smart locks of the building. For example, the primary exterior lock interface 202a may be interacted with by the user of the primary exterior lock interface 202a to command some or all of the smart locks of the building to change lock states. In response to receiving the command by the user, the primary exterior lock interface 202a may transmit a control signal number to some or all of the smart locks of the building (e.g., the primary interior lock interface 202b and the secondary lock interfaces 204a-204n) either directly or indirectly (e.g., via the hub 206). In some embodiments, the primary exterior lock interface 202a transmits an instructional signal or command number to one or more of the other smart locks (e.g., secondary interior lock interface(s) 204) and the smart lock(s) applies a control signal to cause an associated actuator to adjust the state of the corresponding lock. In other embodiments the primary exterior lock interface 202a may transmit an instructional signal number to the hub 206, which interprets the instructional signal and transmits a corresponding control signal number to the appropriate smart locks. The primary exterior lock interface 202a may be used to lock/unlock some all of the smart locks by broadcasting signals to smart locks or communicating the signals to individual smart locks that are network addressable.

In response to receiving an indication that the state of one or more smart lock has changed, a corresponding indicator for each smart lock on each of the smart locks (e.g., on secondary interior lock interfaces 204) transitions to a state that corresponds with the current state of each respective smart lock.

In various embodiments, each smart lock of the building may serve as a central location to control one or more other smart locks of the building. In such embodiments, each smart lock of the building may function in substantially the same manner as the primary exterior lock interface 202a, as described above. By way of example, the primary interior lock interface 202b may be used to alter the state of one or more smart locks of the system 200. Likewise, each of the secondary interior lock interfaces may be used to adjust the state of each smart lock of the system 200.

In some embodiments, the primary exterior lock interface 202a may be configured to require a password authentication from the user through a user input of the primary exterior lock interface 202a. The password may depend on the type of user interface on the primary exterior lock interface 202a. If the user interface is a keypad, the password may be a sequence of digits. If a camera is on the primary exterior lock interface 202a, a facial recognition may be considered a password. Other biometrics, swipes, or passwords may be possible. Responsive to receiving a user input through the input of the primary exterior lock interface 202a, the primary exterior lock interface 202a may compare the user input to a stored (either locally or remotely) authenticator key. In response to the user input matching the stored authenticator key, the primary exterior lock interface 202a may be used to adjust the lock state of any smart lock on the system 200. The primary exterior lock interface 202a may give one or more indications that the user input matches the stored authenticator. For example, the primary exterior lock interface 202a may present an audible indication of a match, a visual indication of a match, and/or a haptic indication of a match.

For ease of description, the secondary lock interfaces 204a-204n are described in the singular. However, the description of the secondary lock interface 204a may be extended to any or all secondary lock interfaces 204a-204n. The secondary lock interface 204a may be (or include) any type of electronic device comprising hardware components (e.g., one or more processors, non-transitory storage, wireless communication electronics, etc.) and software components or modules configured to perform the various processes and tasks described herein. Non-limiting examples of the computing devices of the secondary lock interface 204a and computing devices that may interact therewith to support the functions thereof include smart home devices (e.g., smart locks), personal computers (e.g., laptop computers, desktop computers), server computers, mobile devices (e.g., smartphones, tablets), smart watches, among other types of electronic devices. In an exemplary embodiment, the secondary lock interface 204a is an interior smart lock for the secondary door. As will be described in greater detail in FIG. 3B, the secondary lock interface 204a may include a user display, a user input, a communication module, a thumb turn interface and a physical housing. The secondary lock interface 204a may be mounted (e.g., located, installed, placed) on an interior of the secondary door(s) at a lock and/or thumb turn thereof.

The secondary lock interface 204a may include at least one processor that executes one or more software programs to perform various processes (e.g., the process 700 of FIG. 7 and/or the process 800 of FIG. 8). In other embodiments, the secondary lock interface 204a may enable a mobile computing device (e.g., cellular device) to be communicatively coupled to a locking mechanism to communicate control signals therewith to cause the secondary lock interface 204a to change from a lock state to an unlock state and vice versa. The system 200 may include any number of secondary lock interfaces 204. In some cases, the computing devices of the secondary lock interface 204a may be configured to perform all or portions of the processes of the hub 206, the primary exterior lock interface 202a, and/or the primary interior lock interface 202b. The secondary lock interface 204a may also include various hardware (e.g., actuators) to lock or unlock a lock of the secondary door, as shown in greater detail in FIG. 3B. In addition, the secondary lock interface 204a may include one or more indicators (e.g., speakers, lights, displays, haptic devices, etc.) to indicate a state of one or more smart locks (e.g., the primary interior lock interface 202b and other secondary interior lock interfaces 204). By way of example, the secondary lock interface 204a may include multiple illumination devices (e.g., LEDs) on a housing thereof. Each illumination device may correspond with a different smart lock of the building. Each illumination device may have two states, a first state (e.g., illumination ON) associated with a locked state of the smart lock and the second state (e.g., illumination OFF) associated with an unlocked state of the smart lock. In this way, the user may quickly identify based on the indicators the state of each smart lock of the building from a central location.

The user device 216 (e.g., a mobile electronic device, such as a smartphone) may be any type of electronic device comprising hardware components (e.g., one or more processors, non-transitory storage medium, user interface) and software components capable of performing the various processes and tasks described herein. By way of example, the user device 216 is distinct from the computing device of FIG. 1, however, the user device 216 may be the same computing device 108 of FIG. 1, in which case the description is incorporated herein. Non-limiting examples of the user device 216 include personal computers (e.g., laptop computers, desktop computers), server computers, mobile devices (e.g., smartphones, tablets), VR devices, and gaming consoles, smart watches, among other types of electronic devices. In an illustrative embodiment, the user device 216 is a mobile electronic device executing one or more mobile applications that are configured to communicate with (e.g., transmit to and receive from) the various components of the system 200. The user device 216 may include an electronic display, a user interface, communication electronics, and a physical housing.

The user device 216 may include one or more computing devices configured to execute one or more software programs (e.g., mobile applications or apps) to perform various processes (e.g., the process 700 of FIG. 7 and/or the process 800 of FIG. 8). In some embodiments, the user device 216 may be a computer or computing device capable of performing the same or similar methods disclosed herein as performed by the user device 216. The user device 216 may include a processor and non-transitory, computer-readable medium including instructions, which, when executed by the processor, causes the processor to perform methods disclosed herein. Although FIG. 2 shows only a single user device 216, the user device 216 any include any number of devices associated with one or more users. In some cases, the computing devices of the user device 216 may perform all or portions of the processes of the primary exterior lock interface 202a, the primary interior lock interface 202b, the secondary lock interfaces 204a-204n, and/or the hub 206.

By way of example, the user of the system 200 may interact with the user device 216 to select one or more selectable elements 218 or buttons (each element 218 may be associated with a corresponding smart lock/door) to adjust from a first state (e.g., unlocked) to a second state (e.g., locked). The user may then select the element 220 to indicate whether to adjust the corresponding smart lock/door from the first state to the second state or the second state to the first state. In response to receiving the indications of the selected elements 218, 220, the user device 216 transmits control signals (either directly or indirectly) to the various locks/doors corresponding to the selected element 218 to execute the indicated transition between states as indicated by the selected elements 218, 220. In an embodiment, rather than having to interact with multiple elements 218, 220, the elements 218 may control both selection and state of the smart lock/door by, for example, holding the element 218 for a certain period of time or tap an element multiple times within a maximum time period (e.g., 2 taps within 0.5 seconds). Other user interface elements and processes for interacting with these elements may be provided and utilized in performing the locking and unlocking.

Control and informational signals may be transmitted between the components of the system 200. For example, the signals 214a, 214b, 214c, 214d, 214e, 214f, and/or 214g may be transmitted between and amongst components through the network(s) 212. As described herein, the signals 214a-214g may be transmitted utilizing any suitable communication protocol. According to illustrative embodiments, the signals 214a-214g may be transmitted directly between components of the system 200. Alternatively or additionally, the signals 214a-214g may be transmitted from a smart lock in response to a user changing a lock state thereof or to a single component (e.g., the hub 206 and/or the primary exterior lock interface 202a) and then relayed from the single component to one or more other components of the system 200.

Turning now to FIG. 3A, a door smart lock system 300 may include a primary exterior lock interface 302a and a primary interior lock interface 302b for controlling one or more locks associated with a building or other structure are shown. The primary exterior lock interface 302a and the primary interior lock interface 302b may be components that are packaged and sold as a kit. As described with regard to FIG. 2, the primary exterior lock interface 302a may be configured to be mounted to an exterior or front side of a door of the building, and the primary interior lock interface 302b may be configured to mount to an interior or back side of the door of the building. To avoid confusion, the exterior or exterior side of the door of the building may be considered outside the building, and the interior or interior side of the door of the building may be considered inside the building such that a person entering the building approaches the exterior side of the door and a person exiting the building approaches the interior side of the door. In various embodiments of the current disclosure the primary exterior lock interface 302a may be mounted to the exterior of the primary door of the building, the primary exterior lock interface 302a may also be mounted to an exterior surface of the building or other structure exterior to the building. In some embodiments, the primary exterior lock interface 302a is a mobile computing device and not mounted to any structure. Likewise, the primary interior lock interface 302b may be mounted to the interior of the building at a position other than an interior of the door. For example, the primary interior lock may be mounted on a door frame of the primary lock, a wall of the building, or located on a horizontal surface. However, given that the primary interior lock interface 302b is to physically lock and unlock a lock (e.g., deadbolt) of the door, at least a portion of the primary interior lock interface 302b is to engage with a lock control mechanism of the door to enable a user to lock and unlock the door, as further described herein.

In an alternative embodiment, the primary exterior lock interface and the primary interior lock interface may be configured to replace an existing lock or at least a portion thereof (e.g., replace a thumb turn of the existing lock) such that the primary exterior lock interface and the primary interior lock interface may both connect to and/or engage with the respective exterior and interior sides of the door along with directly or indirectly connecting with and/or engaging one another via connection components (e.g., bolts) and/or otherwise. In an embodiment, communications between the primary interior and primary exterior lock interfaces may be wireless or wired (e.g., optionally via a plug-in connector that extends through the door via a lock region. In an embodiment, a secondary interior lock interface may be configured to retrofit an existing lock such that the secondary interior lock interface engages with a thumb turn of a deadbolt lock, replaces a portion of or the entire lock. As previously described, the secondary interior lock interface may be configured to enable a user to manually or cause a signal to automatically rotate the thumb turn to a locked state or an unlocked state. If the secondary interior lock interface is configured to replace a portion of or an entire lock, the secondary interior lock interface may be configured to engage both the interior and exterior sides (i.e., indoor and outdoor surfaces) of the door.

The primary exterior lock interface 302a may include a housing 303 that contains various components, including a user interface 305, an electronic display 306, and optionally a sensor 310. These components of the primary exterior lock interface 302a may be contained in a single physical housing 312 or contained in multiple physical housings. It should be understood that additional and/or alternative components or different component configurations may be utilized.

The electronic display 306 may be configured to display information and/or data to a user of the door smart lock system 300. The electronic display 306 may be a display screen (e.g., LED screen, OLED screen, etc.) or individual elements that have associated lighting devices (e.g., LEDs). The electronic display 306 may be configured, in certain embodiments, to display the lock state of one or more smart locks, an alarm state of a home alarm system of the building associated with the door smart lock system 300, an energy/battery level of the primary exterior lock interface 302a, user presence indications, activity information, and/or other smart lock and alarm related data.

The user interface 305 may be a keypad and include one or more input elements 308a, 308k. The input elements 308a-308j may corresponding to alpha numeric characters. By a user interacting (e.g., pressing, clicking, swiping, touching or otherwise gesturing) with the input element(s) 308a-308j, the user may cause the primary exterior lock interface 302a to transmit control signals to one or more components of smart lock system 300 of the building. These components may include the various smart devices as described in FIGS. 1 and 2, including one or more of the interfaces, hubs, etc., of smart locks, and the control signals may be configured to cause the one or more of the smart lock interfaces to transition/adjust the lock state of respective locks of doors of the building. The input elements 308a-308j may be used by the user to input an authentication token (e.g., password or keycode) to be compared, by the primary exterior lock interface 302a (or a server or hub) to a stored authentication key. In an embodiment, in response to confirming (or receiving an indication from the server or hub of confirmation) that the input authentication token matches the stored authentication key, the primary exterior lock interface 302a may display an indication of the match confirmation (e.g., turn ON an illumination device, output an audio signal, etc.). In response to confirming a match of the authentication token with the authentication key, the user may then selectively control one or more smart locks of the building through interacting one or more of the input elements 308a-308j and the input element 308k. For example, the user may indicate one or more smart locks to transition (e.g., lock or unlock) with the input elements 308a-308j (e.g., select a user input associated with a corresponding smart lock) and then indicate a command to adjust or toggle the lock state with the input element 308k. In response to receiving, by the primary exterior lock interface 302a, the indication to adjust the lock state of the one or more smart locks, the primary exterior lock interface 302a may directly or indirectly transmit a control signal to the one or more smart locks. In some embodiments, the user may interact with the input element 308k in a predefined manner to adjust multiple locks at once. For example, the user may click and hold the input element 308k to lock all of the smart locks of the building upon leaving the building. While the example given above describes clicking and holding the input element 308k, it should be understood that any interaction with the user interface 305 or input elements 308a-308n may be used to adjust one or more of the smart locks of the building. Alternative and/or additional gestures or interactions that may be used by the user to indicate a command to adjust a lock state may include double clicking the input element 308k, swiping a gesture on a touch screen, using a voice command, using a bio authenticator, etc.

The primary interior lock interface 302b may be mounted over and engage with a manual thumb turn of a dead bolt of a primary door of the building on which the interfaces 302a and 302b are mounted. The primary interior lock interface 302b may include an input element 314, a grip element 316 an indicator 318, a removable battery 320, and/or one or more indicators 322a-322n. The shape and size of the input element 314, grip element 316, indicator 318, and indicators 322 may be different, but perform the same functionality.

More particularly, a back side of the input element 314 may be configured to be placed onto and functionally engage a manual thumb turn of a dead bolt of the primary door upon which the primary interior lock interface 302b is mounted. The input element 314 may be configured to interface with the manual thumb turn so as to turn the manual thumb turn when the input element 314 is turned. The input element 314 may include a grip element 316 with which the user of the door lock system 300 may grip. The input element 314 protrudes away from the input element 314 so as to provide a grippable surface with which the user may interact. As shown in the FIG. 3A, the input element 314 may be circular and the grip element 316 may be a single, linear protrusion from the surface of the input element 314. However, it should be understood that the input element 314 and the grip element 316 may be any suitable shape or geometry that enables a user to rotate the thumb turn that is engage to the grip element 316. The primary interior lock interface 302b may include various alternative and/or replaceable input elements 314 to interface with various differently shaped manual thumb turns. In such embodiments, the input element 314 may be removable and replaceable so as to physically match and engage an indentation, slot, or other engagement feature on a door-side of the primary interior lock interface 302b to engage manual thumb turn installed on the door.

The input element 314 may be manually and/or electrically actuated. For example, a user may rotate the input element 314 90 degrees, which may rotate the manual thumb turn 90 degrees so as to lock/unlock the lock of the door. In some embodiments, the input element 314 is alternatively or additionally electromechanically actuated. In such embodiments, the primary interior lock interface 302b may send control signals to an actuator (e.g., motor) mechanically coupled to the manual thumb turn and/or the input element 314 to cause the input element 314 to rotate clockwise or counterclockwise. That is, the control signals transmitted to the actuator may cause the actuator to adjust a position of the deadbolt of the door from an unlocked to a locked state or a locked state to an unlocked state. The control signals may come from any component (e.g., primary exterior lock interface 302a) of the door lock system 300, from a mobile device (e.g., mobile app executed on the mobile device, hub, computer, etc.).

In some embodiments the input element 314 is not mechanically coupled to the dead bolt of the door, but rather another feature that is controlled by the input element 314 may be directly or indirectly coupled to the lock of the door. In such embodiments, the input element 314 may receive commands and/or interactions from the user which may then cause the primary interior lock interface 302b to transmit control signals to the actuator of the primary interior lock interface 302b to adjust the deadbolt of the primary door.

The indicator 318 may be used to indicate a lock state of one or more smart locks of the building associated with the door lock system 300. In some embodiments, the indicator 318 may indicate the locked state of the primary door. In other embodiments the indicator 318 may show or indicate the locked status of all of the smart locks of the building. For example, the indicator 318 may be used to indicate if all the smart locks of the building are in a locked state. In such embodiments, the indicator 318 may be lit when all locks are locked or be unlit when at least one lock of the building is unlocked. The indicator 318 may be configured to display more than two states. For example, the indicator 318 may display various colors, brightness, hues, etc. to indicate additional states (e.g., armed, battery level, door position, communication status, etc.) of one or more smart locks. While the indicator 318 is shown as a light, it should be understood that the indicator 318 may be any indicator described herein (e.g., speaker, haptic engine, electronic display).

The removable battery 320 may supply energy to the primary interior lock interface 302b and all of the associated electronics and/or components. The removable battery 320 may be configured to be removed from the primary interior lock interface 302b. In some embodiments the primary interior lock interface 302b includes multiple removable batteries 320 which may be alternatively used. For example, a first removable battery 320 may be installed on the primary interior lock interface 302b so as to supply energy to the primary interior lock interface 302b while a second removable battery 320 is being charged. Upon the first removable battery 320 dropping below a certain threshold, the primary interior lock may send an alert or notification to the user of the door lock system 300 of the exceeded threshold. The user may then remove the first removable battery 320 and replace it with the second removable battery 320. In some embodiments, the removable battery 320 is additionally electrically coupled to the primary exterior lock interface 302a and supplies power to the primary exterior lock interface 302a.

The indicators 322a-322n may be used to indicate a lock status of one or more smart locks of the building. The indicators 322a-322n may have a first state to indicate a locked state of a corresponding lock and a second state to indicate an unlocked state of the corresponding smart lock. For example, the indicator 322a may be associated with the primary interior lock interface 302B and the indicator 322n may be associated with a secondary lock interface 304 of FIG. 3B. The indicator 322a may be lit (e.g., the first state) when the primary interior lock interface 302b is in the locked state and unlit (e.g., the second state) when the primary interior lock interface 302b is in the unlocked state. Likewise, the indicator 322n may be lit when the secondary lock interface 304 of FIG. 3B is in a locked state and the indicator 322n may be unlit when the secondary lock interface 304 of FIG. 3B is in an unlocked state. The indicator 322a may display the lock state of the primary interior lock interface 302b simultaneously as the indicator 322n displays the lock state of the secondary lock interface 304. While FIG. 3A illustrates the indicators 322a-322n as being visual indicators (for example LEDs), it should be understood that the indicators 322a-322n may be any suitable mechanism and/or device and/or component that may be used to indicate to the user a lock state of each lock of the building. Alternative or additional indicators may include haptic devices, displays, and/or speakers that output audible signals or messages. The indicators 322a-322n may be configured to display more than two states. For example, the indicators 322a-322n may display various colors, brightness, hues, etc. to indicate additional states (e.g., armed, battery level, door position, etc.) of one or more smart locks.

As with the user interface 305 of the primary exterior lock interface 302a, the input element 314 may be used to control the locked state of one or more smart locks of the building. By way of example, the input element 314 may be adjusted to a first orientation (clockwise 90 degrees) to individually lock the primary interior lock interface 302b of the building while a second orientation (counterclockwise 90 degrees) may collectively lock all of the smart locks of the building. For example, rotating the input element 314 to the first orientation (e.g., 45 degrees) may cause a transmission of a control signal to lock the primary interior lock interface 302b of the building. Rotating the input element 314 to the second orientation (e.g., 90 degrees) may cause a transmission of control signals to one or more (e.g., all) of the smart locks of the building to potentially change their states to a locked state if currently in an unlocked state. The primary interior lock interface 302b may send a single control signal that is transmitted or broadcast to some or all of the smart locks or different control signals to each smart lock. In some embodiments, the primary interior lock interface 302b may transmit a single control signal to a single component (e.g., a hub), which may then transmit control signals to one or more of the smart locks (e.g., to any smart locks that are known to be unlocked).

The above first and second orientations are given for illustrative purposes, and it should be understood that the primary interior lock interface 302b may have multiple orientations corresponding to multiple commands. Additional or alternative orientations may include pushing in the input element 314, pulling out the input element 314 sliding the input element 314, rotating the input element 314 a full 360 degrees, swiping the input element 314, tip/tilting the input element 314, etc. Additionally, the input element 314 may have more than one state in which the user may adjust the input element 314 between orientations. By way of example, the input element 314 may be rotated to the first orientation when the input element 314 is pushed in (a first state) or when the input element 314 is pulled out (a second state). In this embodiment, the primary interior lock interface 302b may transmit distinct communication signals depending on the state of the input element 314. For example, if the input element 314 is adjusted when in the first state (e.g., pushed in), the primary interior lock interface 302b may cause an adjustment to a plurality of locks (e.g., all locks) of the door smart lock system 300. If the input element 314 is adjusted when in the second state (e.g., pulled out) the primary interior lock interface 302b may cause an adjustment to a single lock (e.g., the lock associated with the primary interior lock interface 302b). The input element 314 may have a plurality of states, orientation, positions, etc. that may be combined to cause various discreet and distinct actions, processes, methods, communications etc. Furthermore, this input element 314 or other feature (e.g., push button) may disable the input element 314 from being rotated mechanically or automatically. Still yet, wireless communication may be disabled by a setting of the input element or other feature.

Turning now to FIG. 3B, an illustration of an illustrative secondary lock interface 304 is shown. The secondary lock interface 304 may be substantially similar to the primary interior lock interface 302b of FIG. 3A. In various embodiments, the secondary lock interface 304 may be positioned on a secondary door (i.e., not a door on which the primary exterior and interior lock interfaces 302a and 302b are positioned) of the building. In an embodiment, the door smart lock system 300 may include a single primary exterior lock interface 302a, a single primary interior lock interface 302b, and a plurality of secondary lock interfaces 304. The secondary lock interface 304 may include a housing 324 that contains an input element 326, a grip element 328, an indicator 330, indicators 332a-332n, and/or a removable battery 334. The various descriptions and embodiments as described in relation to the primary interior lock interface 302b may extend to, and apply, to the secondary lock interface 304.

Disclosed herein are systems and methods capable of addressing shortcomings of existing smart locks. A system as described herein may include a primary smart lock installed on a main door (e.g., front door of a house) and one or more secondary smart locks (e.g., smart lock interfaces installed on non-front doors of a house). The primary smart lock may include two components: an exterior smart lock controller and an interior smart lock interface. The secondary lock may include an interior smart lock interface. According to an illustrative embodiment, the exterior controller may be configured to receive an input from a user to selectably transition one or more (e.g., all) smart locks installed to a respective one or more doors of a space (e.g., house) to a locked or unlocked state. Upon receiving the input from the user to selectably transition one or more smart locks at the space to the locked state, the exterior controller may transmit, either directly or indirectly, a control signal to one or more smart locks to cause the one or more smart locks to transition from an unlocked state to a locked state. In an embodiment, each lock (e.g., internal and external components) may include an indicator corresponding to status of each smart lock installed at the space. Each indicator may be configured to display an indication of a status or state (e.g., “locked,” “unlocked,” “armed,” and/or “unarmed”) of the corresponding smart lock.

In some aspects, a kit may include a controller configured to be mounted on an exterior of a space with multiple doors and one or more walls to enclose the space. A first smart lock interface may be configured to be mounted to an interior of a first door and configured to lock and unlock the first door. The first smart lock interface may further be configured to communicate with the controller such that a first signal communicated to the first smart lock interface from the controller causes the first smart lock interface to transition from an unlocked state to a locked state or from a locked state to an unlocked state. A second smart lock interface may be configured (i) to be mounted to an interior of a second door, and further be configured (ii) to communicate with the controller such that a second signal may be communicated to the second smart lock interface from the controller to cause the second smart lock interface to transition from an unlocked state to a locked state or from a locked state to an unlocked state.

One embodiment of a security system may include a controller configured to be mounted on an exterior of a space with multiple doors and one or more walls to enclose the space. A first smart lock interface may be configured to be mounted to an interior of a first door, and further be configured to lock and unlock a first door. The first smart lock interface may further be configured to communicate with the controller such that a first signal communicated to the first smart lock interface from the controller causes the first smart lock interface to transition from an unlocked stated to a locked state or from a locked state to an unlocked state. A second smart lock interface may be configured to be mounted to an interior of a second door, and further be configured to communicate with the controller such that a second signal communicated to the second smart lock interface from the controller may cause the second smart lock interface to transition from an unlocked state to a locked state or from a locked state to an unlocked state.

The first smart lock interface may be configured to fit over a manual thumb turn of a deadbolt on the first door, and be configured to actuate the manual thumb turn to lock or unlock the first door. In an embodiment, the first smart lock interface may enable manual or remotely controlled locking and unlocking. Remotely controlling may include being controlled by a controller disposed on an opposite side of a door on which the first smart lock interface may be secured.

One embodiment of a computer-implemented method may include receiving, by one or more processors, a lock status of one or more of smart locks associated with a structure. The processor(s) may display the lock status of the smart locks on an electronic display. The processor(s) may receive an indication to transition the smart locks to a locked state. An instruction may be transmitted to the smart locks to adjust each smart lock to the locked state. An updated lock status may be received from the smart locks associated with the structure. The updated lock status of the smart locks may be displayed on the electronic display.

### Door Lock Deter Light

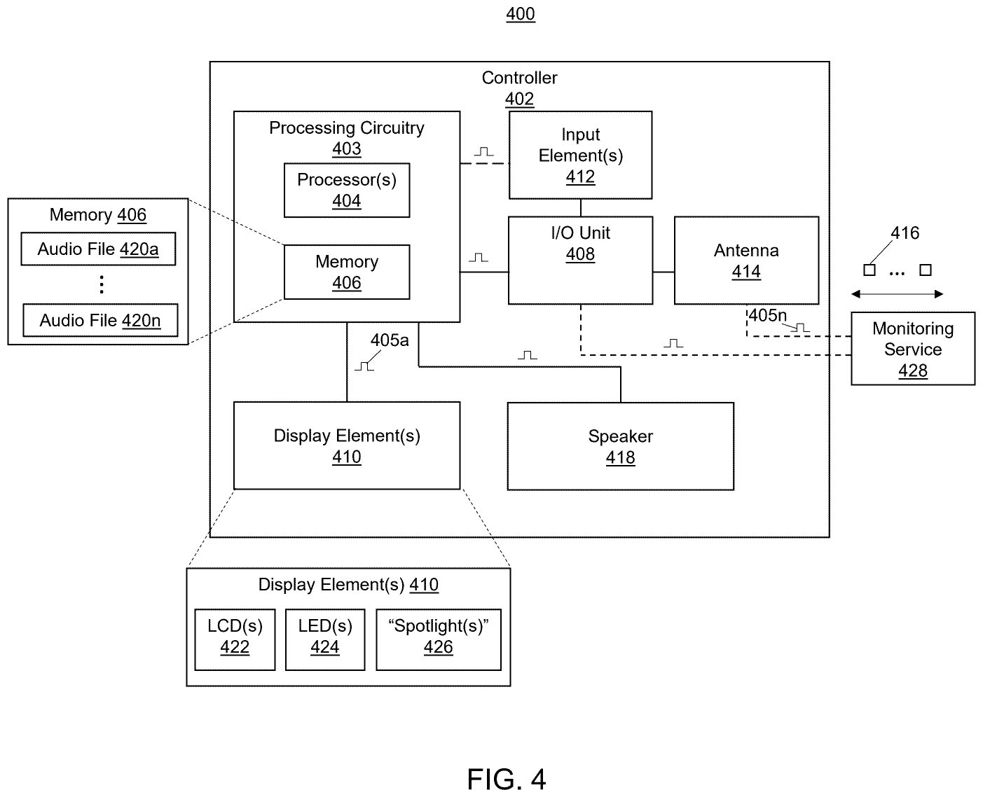

Turning now to FIG. 4, a block diagram of an illustrative system 400 including a controller 402 for use in controlling and operating one or more smart locks (or smart lock interfaces) and for providing deterrence to unknown people is shown. The controller 402 may include multiple electronic circuits and modules, including processing circuitry 403 including one or more processors 404 and a memory 406, an input/output (I/O) unit 408, one or more display element(s) 410, input element(s) 412, antenna(s) 414 for communicating signals 416 (e.g., communication signals, control signals, data signals, etc.) over one or more frequency bands and using one or more different communication protocols, and so on. The processor(s) 404 may be general processors, image processors, digital signal processors, application specific integrated circuits, and/or otherwise configured to execute software to manage operations of the processing circuitry 403 for communicating with and operating the smart lock(s). It should be understood that other components, such as camera(s) speaker(s), illumination devices(s), biometric sensors, motion sensor(s), range sensor(s), or otherwise may be integrated into the controller 402 and be supported by the processing circuitry 403, software being executed thereby, and/or other electronic components. The processing circuitry 403 may be configured to communicate directly or indirectly using signals 405a-405n (collectively 405) that are over a bus, such as a controller area network (CAN) bus, or otherwise, and may be digital, analog, or a combination thereof depending on the data and devices with which the processing circuitry 403 is communicating.

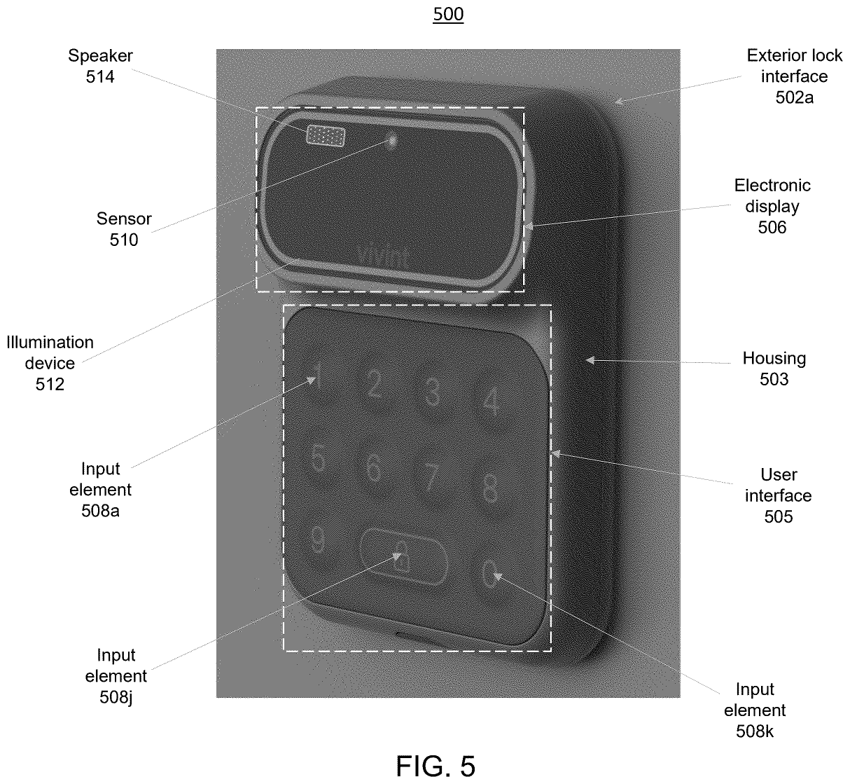

The display element(s) 410 may further include a liquid crystal display (LCD) 422, light emitting diode(s) (LED(s)) 424, and/or “spotlights” 426. The LCD 422, LED(s) 424, and/or spotlights 426 may be configured to generate a visual illumination (or light) signal to a person approaching a door at which an exterior lock interface inclusive of the controller 402 is disposed. An illumination signal may be a deterrence illumination signal associated with a deterrence state or a non-deterrence illumination signal associated with a non-deterrence state. As an example of a deterrence state, an outer portion of the LCD 422 may be configured to output an illumination signal (e.g., glow) in a bright red color in the shape of a ring (e.g., as shown in FIG. 5) for a time period of 10 seconds to suggest a warning for potential intruders. In another example, LED(s) 424 may flash with alternative colors (e.g., blue and red colors displayed in a ring shape), each color being displayed for a first time period (e.g., 0.5 seconds) before transitioning to the alternate color for a second time period (e.g., 0.5 seconds), with the entire sequence repeating for a third time period (e.g., 10 seconds). In another example, the spotlight(s) 426 may be directed towards and configured to illuminate on a person outside of the door in a bright white color, or with a strobe effect. In an example illustrative of a non-deterrence state, the LCD 422 may be configured to activate in an “OFF” state (e.g., remaining “OFF,” or transitioning to “OFF” from “ON” following successful identification of a known user). In another embodiment, the LCD 422 may be configured to emit a soft green light accented by warm-white spots generated by the LED(s) 424. While illustrative examples are discussed above, numerous additional/alternative illumination signals and illumination signal combinations may be generated by the LCD 422, LED(s) 424, and/or spotlight(s) 426 and be associated with activating a deterrence state or non-deterrence state.

Further, the system 400 may include a speaker 418. The speaker 418 may be a dynamic (or moving coil) speaker, balanced armature (BA) speaker, piezoelectric speaker, electrostatic(ES) speaker, planar magnetic (PM) speaker, horn speaker, or any other speaker configured to output an audible signal to a person at a door at which the speaker is disposed. Further, the memory 406 of the controller 402 may contain audio files 420a-420n (collectively 420) that may be output by the speaker 418. Each of the audio file(s) 420 may be in various formats including Waveform Audio File Format (WAV), MPEG Audio Layer III (MP3), Advanced Audio Coding (AAC), Free Lossless Audio Codec (FLAC), Windows Media Audio (WMA), or any other format capable of producing an audible signal associated with the audio file(s) 420. Further, each audible signal associated with each of the audio files 420 may be configured to have a different intended effect on a person hearing the audible signal. As described above with regard to illumination signals, an audio file 420 (and corresponding audible signal) may be associated with a deterrence state or a non-deterrence state. For example, audio file 420a may be associated with a deterrence audio state designed to deter an intruder using an aggressive and/or surprising sound (e.g., breaking glass or siren) when output by the speaker 418. In another example in which a person is identified and on a “blacklist,” the audio file 420a may include the name of the person in the audible signal (e.g., “Get off my porch, John Doe!”). In addition, the audio file 420n may be associated with a non-deterrence audio state. For example, one or more audio file(s) 420 may be configured to inform a known person that the person has been identified as a known person, that alarm system has been deactivated, and/or that the door lock has been unlocked (e.g., “Welcome, Known User”).

The processing circuit 403 may be configured to select an appropriate audio file from the audio files 420 and transmit the audio file 420 as a digital signal to the speaker 418. The speaker 418 may then output the digital signal as an audible signal that may be heard by a person positioned within an audible range of the speaker 418. For example, if a person has been identified as a known person, the processing circuit 403 may select an audio file 420 associated with a non-deterrence state (e.g., “Welcome Home”). The speaker 418 may be configured to output the audio file 420 as an audible signal to a person in proximity to the controller 402 (or door lock interface), such as an authorized user of the smart lock system (e.g., a resident of a home). If a person has been identified as an unknown person (e.g., a potential intruder), the processing circuit 403 may select an audio file 420 associated with a deterrence state (e.g., siren or “I'm calling the police!”), and the speaker 418 may output the audio file 420 as an audible signal capable of being heard by the potential intruder. In alternative embodiments, the speaker 418 may be exclusively integrated into the door lock interface instead of the controller 402 as an external speaker, and the processing circuit 403 may be configured to transmit an appropriate audio file to the external speaker as a digital signal via the I/O unit 408 or the antenna 414. The controller 402 may further transmit digital signal(s) to a monitoring service 428 via the I/O unit 408 or the antenna 414, as described in greater detail with regard to FIG. 8.

With regard to FIG. 5, a perspective view of an illustrative door lock system 500 including an exterior smart lock interface 502 inclusive of an illumination device 512 is shown. The exterior door lock interface 502a may have the same or similar features as the primary exterior door lock interface 302a of FIG. 3A, but include additional features that enables a user of the exterior door lock interface 502a to deter a person (or potential intruder) at a door before the person accesses or attempts to access the door secured by the smart lock system.

As with the exterior door lock interface 302a of FIG. 3A, the exterior door lock interface 502a may include a housing 503 on which a user interface 505 and electronic display 506 are positioned. As shown, the user interface 505 may include input elements 508a-508k (collectively 508). It should be understood that an alternative user interface, such as a touch pad or otherwise, may be utilized. The exterior lock interface 502a may also include a sensor 510 configured to sense a space near which the exterior lock interface 502a is located (e.g., a front porch). The exterior lock interface 502a may further include an illumination device 512 configured to illuminate in a manner associated with a deterrence state or a non-deterrence state, and a speaker 514 configured to output an audible signal.

The sensor 510 may be a camera, microphone, and/or other type of sensor including: optical cameras (for image capture and facial recognition), Infrared (IR) sensors (for detecting heat signatures and distance), Ultrasonic sensors (for proximity detection), Micro-Electro-Mechanical Systems (MEMS) microphones (for audio capture and voice recognition), Optical and Capacitive biometric sensors (for identity verification), Passive Infrared (PIR) and Microwave motion detectors (for movement detection), Doppler Radar sensors (for movement tracking and speed measurement), Near Field Communication (NFC) modules (for short-range wireless interaction), Bluetooth and Wi-Fi modules (for wireless connectivity), Global Positioning System (GPS) modules (for geolocation), Light Detection and Ranging (LIDAR) sensors (for three-dimensional environmental mapping), and/or others.

In an embodiment, the system 500 may include a plurality of sensors 510 instead of a single sensor, and data from each of the plurality of sensors 510 may be combined to determine whether a person is at a door of a space secured by the system 500 and needs to be deterred (e.g., during identification). For example, the system 500 may include an optical camera configured to image a space that a user of a smart lock system wants to monitor. The system may further include an ultrasonic sensor configured to monitor the same area. To identify a person at the door of the space, data from the optical camera (e.g., an image of a front porch including an entity that may be a person) and the ultrasonic sensor (e.g., distance information corresponding to the distance of the entity from the sensor) may be combined to determine whether to activate the system to be in a deterrence state or non-deterrence state. Various additional/alternative sensors 510 or combinations of sensors 510 may be utilized for the same or for similar purposes as described above. Further, the plurality of sensors 510 may be disposed on the exterior lock interface 502a (e.g., as shown with regard to the single sensor 510). In another embodiment, one or more sensors of the plurality of sensors 510 may be included on another smart lock or smart lock interface, a security camera, etc., and data from each of the plurality of sensors 510 may be received by the system 500 and used in deterring a potential intruder.

To support illuminating specific features and/or specific features in certain colors, light channels and/or illumination devices capable of illuminating in different colors (e.g., LEDs of different wavelengths or LED(s) capable of being illuminated with different wavelengths) may be utilized, such as the illumination device 512. Alternative icons or indicators (e.g., LEDs) may be utilized to provide additional information (e.g., lock and security system states).

In one embodiment, the illumination device 512 may be configured to activate in a manner associated with a deterrence state or a non-deterrence state, as described with regard to FIG. 4. As shown in FIG. 5, the illumination device 512 may generate a red-colored, ring-shaped illumination signal along the outer portion of the electronic display 506. For example, the illumination device 512 may include multiple LEDs (e.g., red LEDs), which may outline the periphery of the display, include rounded vertices, and appear as a distinct visual boundary separating the electronic display 506 from the housing 503 of the exterior lock interface 502a. The illumination device 512 may incorporate light-diffusing elements to create a uniform light signal or “glow.” Alternatively, the illumination device 512 may include discrete illumination elements (e.g., LEDs) positioned along the edge of the display and be configured to enable individualized control over each element. The shape, color, brightness, and other characteristics of the “red ring” shown in FIG. 5 may be selected for high visibility and association with caution, but additional/alternative colors, shapes, brightness, and configurations may also be utilized depending on the environment in which the illumination device is located and additional operational parameters. The red ring may be considered to be ornamental, as other shapes (e.g., circle, diamond, oval, or otherwise) may alternatively be used. In another embodiment, the illumination device 512 may be configured to emit intermittent flashes or pulses of red light (e.g., in a manner indicative of an active sensing state). The illumination signal(s) produced by the illumination device 512 may be configured to display indefinitely (e.g., until turned OFF by a user), to display for a predefined time period (e.g., 10 seconds), to display until a person has exited the monitored area, and/or otherwise. The illumination device 512 may also include a structure (e.g., light tube with a translucent or transparent front-facing side such that light in the light tube is output and viewable by an intruder).

In another embodiment, the illumination signal generated by the illumination device 512 may be configured to dynamically intensify over time or in response to certain actions or environmental conditions. For example, the illumination device 512 may be configured to display in a first deterrence illumination state (e.g., a static red ring as shown in FIG. 5) upon first identifying an unknown person at a door. If the person remains at the door beyond a predefined duration after the static red ring is displayed, an escalation process may occur, and the illumination device 512 may be configured to activate a second deterrence illumination state (e.g., a pulsing red ring), a third deterrence illumination state (e.g., a strobing white and red ring), and so on. If the first deterrence state is not effective in deterring the person at the door, the illumination device 512 may transition to the second state, then to the third state, and so on. In an embodiment, the first deterrence illumination state may provide the lowest level of deterrence and the last illumination state may provide the highest level of deterrence, with each state providing a progressively higher level of deterrence (e.g., brighter lights, more flashes, etc.). Further, the illumination device 512 may be configured to activate (or transition to) the next deterrence illumination state in response to determining that the current state is not an effective deterrent (e.g., upon determining that the potential intruder is still on the porch, is ignoring the signal, or has not noticed the signal). In another example, the illumination device 512 may be configured to adjust the brightness of the illumination signal in response to environmental brightness (e.g., brighter in daytime and/or darker at nighttime).

In an embodiment, the exterior door lock interface 502a may include a speaker 514 that may output audible sound for a person (or potential intruder) to hear. In an embodiment, an audible sound may be associated with a deterrence state or non-deterrence state and outputted such that it may be heard as an audible signal by a person at a door, as described with regard to FIG. 4. Additionally, such sounds may be associated with a successful code entry, an unsuccessful code entry, an unlock request, keystrokes when the input elements 508 are pressed, a transition to lock state, a transition to unlock state, alarm system activation, alarm system deactivation, and more.

Similar to the illumination device 512, the audible signal generated by the speaker 514 may be configured to dynamically intensify over time or in response to certain actions or environmental conditions. For example, the speaker 514 may be configured to output an audible signal corresponding to a first deterrence audio state (e.g., a low-volume chime or beep) upon first identifying an unknown person at a door. If the person remains at the door beyond a predefined duration after first audio signal is output (e.g., 10 seconds), an escalation process may occur, and speaker 514 may be configured to output an audio signal corresponding to a second deterrence audio state (e.g., a loud, repetitive siren) and a third deterrence audio state (e.g., an aggressive human voice stating, “Get off my porch!”). If the first deterrence state is not effective in deterring the person at the door, the speaker 514 may output an audio file associated with a second state, then an audio file associated with a third state, and so on. In an embodiment, the first deterrence audio state may provide the lowest level of deterrence and the last audio state may provide the highest level of deterrence, with each state providing a progressively higher level of deterrence (e.g., louder, more aggressive sounds). Further, the speaker 514 may be configured to transition to the next deterrence audio state in response to determining that the current state is not an effective deterrent (e.g., upon determining that the potential intruder is still on the porch, is ignoring the audible signal, or has not heard the audible signal). In another example, the speaker 514 may be configured to output an audible signal at a higher or lower volume in response to ambient noise in the environment in which the speaker 514 is located (e.g., increasing the volume in response to construction noise next door, or a rainstorm).

In another embodiment, the illumination device 512 and speaker 514 may be used in combination to activate a deterrence or non-deterrence state. For example, a first deterrence state may include only the illumination device 512 being ON (e.g., showing a red ring as shown in FIG. 5). A second deterrence state may include both the illumination device 512 and speaker 514 being ON (e.g., same illumination signal with the speaker now outputting a chime noise), and a third deterrence state may include a flashing illumination signal and louder audio signal. A non-deterrence state may include the illumination device 512 and the speaker 514 being OFF, for example. As described above, the system may automatically transition between the various deterrence and non-deterrence states. Further, the user may also transition between states by providing user input (e.g., via a mobile application showing a real-time or near real-time view of the monitored area) or in response to actions and/or characteristics of the person at the door.

The input element(s) 508a-508k (collectively 508) may be optionally used to instruct the exterior door lock interface 502a to activate a deterrence state or a non-deterrence state. For example, a user may activate the door lock interface 502a to be in a non-deterrence state (e.g., illumination device and/or speaker turned OFF) by pressing and holding the input element 508k for a minimum period of time (e.g., 5 seconds). In an alternative embodiment, rather than pressing and holding an input element, a multi-press action (e.g., pressing the input element 508a two times within a short time period, such as half-a-second) may be used activate the illumination device 512 and speaker 514 of the door lock interface 502a to be in a deterrence state (e.g., illumination device and/or speaker turned ON) or non-deterrence state (e.g., illumination device and/or speaker turned OFF). Other actions using the input elements 508 may be performed for activating/transitioning to deterrence/non-deterrence states, locking/unlocking the door lock, activating/deactivating the security system, and so on. A user of the smart lock system may also instruct the exterior door lock interface 502a to transition to be in a deterrence state or to be in a non-deterrence state remotely via a mobile application or otherwise.

In other embodiments, the system 500 may automatically activate a deterrence or non-deterrence state, as defined by some combination of an illumination signal generated by the illumination device 512 and audible signal generated by the speaker 514, in response to certain actions or characteristics of a person at the door or environmental conditions. Illustrative scenarios that may result in a transition to a higher level of deterrence (i.e., escalation) may include: (i) an unidentified person approaches the door lock interface within a predefined threshold distance (e.g., 5 feet), (ii) a person attempts to tamper with the door lock or keypad (e.g., presses one or more of input elements 508), (iii) a person attempts to access a previously delivered package remaining on a porch, (iv) an unknown person lingers at the door without responding to communication prompts, and/or (v) the system detects multiple access attempts within a short time frame (e.g., 1 hour), potentially indicating unauthorized entry. Alternatively, scenarios that may result in a transition to a lower level of deterrence (i.e., de-escalation) may include: (i) the unidentified person moves away from the door and/or porch area beyond a predefined threshold distance, (ii) the unidentified person presents a valid access credential (e.g., a registered user or delivery personnel with a recognized device ID (e.g., Amazon, UPS, FedEx, name or logo of a known delivery service), (iii) the identified person interacts peacefully with a user via a two-way communication system (e.g., speaker and microphone), (iv) the system receives an authorization signal from the user (e.g., via a mobile app) indicating that the person is identified and authorized to be at the door, and/or (iv) the system detects a malfunction or false identification (e.g., to prevent unnecessary alarm). While the examples above are included for purposes of illustration, it should be understood that various additional/alternative scenarios may be utilized for the same or similar purposes, and each may correspond to some combination of an illumination signal generated by the illumination device 512 and/or audible signal generated by the speaker 514.

In another embodiment, the system 500 may be configured to capture one or more images of a person at or while approaching a door (e.g., via sensor 510), and the electronic display 506 and/or illumination device 512 may be configured to display the captured image(s) to the person at the door to provide deterrence. For example, the electronic display 506 may be an LCD configured to display an image or a near real-time video captured or being captured by the sensor 510 as an unidentified person is at or is approaching a door secured by the system 500 (e.g., a live video of the unidentified person may be displayed to the person via the electronic display 506). In another example, the electronic display 506 and/or illumination device 512 may be configured to display various personal information related to a person, if detected and/or available, approaching a door, such as the person's device identifier(s), name, cell-phone number, publicly available data (e.g., mugshot), or any other information that may be associated with the person so as to provide additional deterrence simply by letting the unidentified person know that personal information has and is being collected.

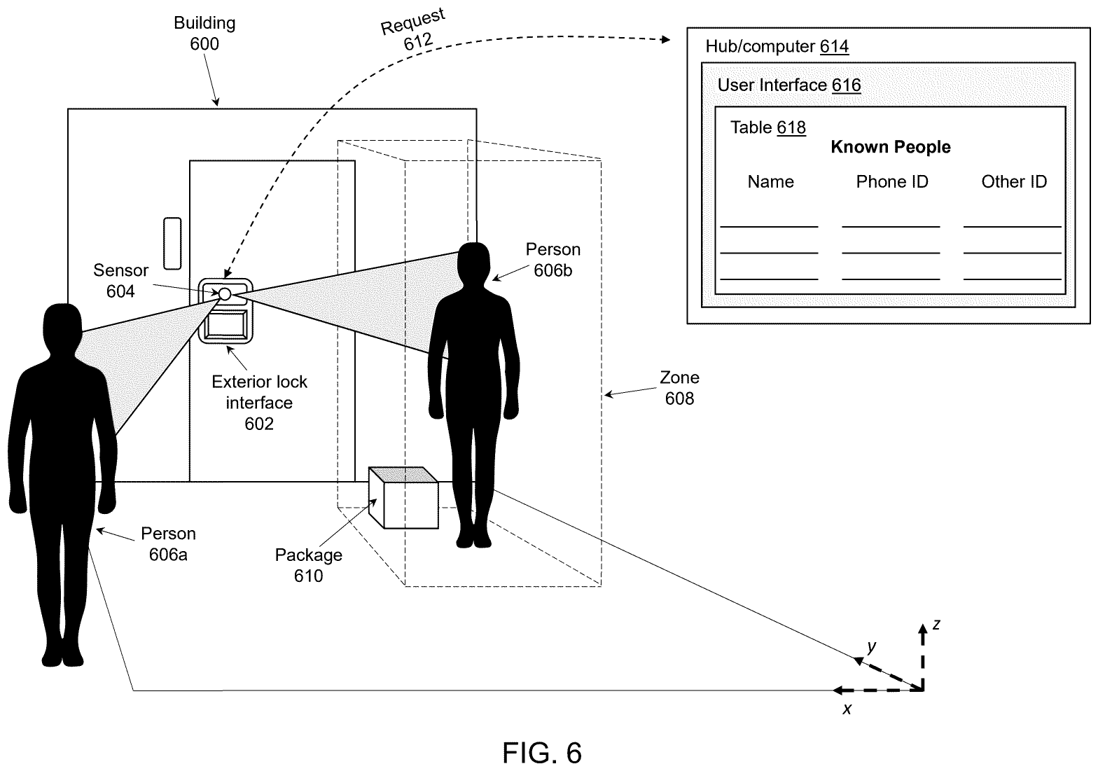

With regard to FIG. 6, a perspective view illustrating one embodiment of a system for deterring a person at a door using a door lock deter light is shown. The system may include a building 600 with an exterior lock interface 602 disposed on an exterior wall of the building 600. The exterior lock interface 602 may include a sensor 604 (as described with regard to the exterior lock interface 502a and sensor 510 of FIG. 5). The sensor 604 may be configured to sense a space proximal to the exterior lock interface 602 (e.g., a front porch near the exterior lock interface). The building 600 may include one or more persons 606a-606b (collectively 606) in the space to be monitored by the sensor 604. For example, the person 606a may be located near an exterior boundary of the space monitored by the sensor 604 such that the person 606a may be sensed by the sensor 604. As another example, the person 606b may be located in a zone 608. The zone 608 may be defined as a three-dimensional segment of the overall area monitored by the sensor 604 and be defined by boundaries specified by Cartesian coordinates in the x, y, and z directions, as shown. For example, the zone 608 may surround a space containing a package 610 located near the building 600.

Upon sensing one or more person(s) 606 (e.g., via the sensor 604 as described with regard to the sensor 510 of FIG. 5), the exterior lock interface 602 may transmit a request 612 to a hub/computer 614. The request 612 may include raw/unprocessed data from the sensor 604 (e.g., an image), processed data from sensor 604 (e.g., an image with identified facial landmarks or characteristics), names/other identifiers of person(s) 606, and more. The hub/computer 614 may further include a user interface 616. The user interface 616 may include information (e.g., in tabular format) utilized in deterring person(s) 606, and this information may accessible and modifiable by a user of the system (e.g., via a mobile application). In an embodiment, such information included in the user interface 616 may include a table 618 containing information related to “Known People,” which may include one or more names, phone identifiers, other identifiers, and/or additional information related to the building 600, exterior lock interface 602, sensor 604, person(s) 606, zone 608, package 610, and more.

The hub/computer 614 may be configured to process information transmitted in the request 612 to identify one or more persons 606 located in the space configured to be sensed by the sensor 604. For example, the hub/computer 614 may be configured to process an image transmitted in the request 612 to determine (i) whether a person is present in the image, (ii) the identity of the person, (iii) whether the person is a known person, and/or additional information related to the operation of the smart lock system and/or exterior lock interface 602. In another embodiment, the exterior lock interface 602 may be configured to process data locally (e.g., via an onboard processor as described with regard to FIG. 4) captured by the sensor 604. For example, the exterior lock interface 602 may be configured to process (e.g., using facial recognition) an image captured by the sensor 604 and locally determine (i) whether a person is present in the image, (ii) the identity of the person, (iii) whether the person is a known person, and/or (iv) additional information. In one example, the exterior lock interface 602 may be configured to identify the one or more person(s) 606 and transmit the identities of the person(s) 606 via the request 612 to the hub/computer 614. The hub/computer 614 may compare the identities included in the request 612 with information contained in the table 618 to determine whether the person(s) 606 are approved as users (e.g., on the list of known users). If the person(s) 606 are not identified and optionally approved, the exterior lock interface may activate a deterrence state, as described above with regard to FIGS. 4-5. For example, the request 612 may trigger the exterior lock interface 602 to activate/deactivate an included illumination device and/or output audio sound via a speaker (as shown on FIG. 5).

The table 618 may include a list of known users (e.g., a “whitelist”) and information corresponding to the known users. In another embodiment, the table 618 may further include a list of banned users (e.g., a “blacklist”) such that, upon identification of one or more person(s) 606 as “banned users,” the exterior lock interface 602 may activate a deterrence state. Various additional/alternative variations of table(s) 618 may be included in the user interface 616 of the hub/computer 614. In another embodiment, table(s) 618 may be stored on a local memory of the exterior lock interface 602 (as described with regard to the memory 406 of FIG. 4). An authorized user of the system may access and/or update information included in the table(s) 618 via a mobile application, a physical hub (e.g., the hub/computer 614), the exterior lock interface 602, or otherwise. For example, a user may add a new roommate to a list of known users included in table 618 by adding information such as the roommate's name, phone number, image, etc. via an “Add Users” page of a mobile application. The table 618 may also include a list of banned people, such as stalkers or a dangerous ex-husband optionally with a restraining court order). Alternatively, the exterior lock interface 602a or hub/computer 614 may automatically access/update information included in the table(s) 618. For example, the exterior lock interface 602 and/or hub/computer 614 may be configured to notice that a previously unknown person 606 is repeatedly accessing the door and is being allowed inside (e.g., a contractor, family member, friend) and, in response, to automatically add information associated with the person 606 (e.g., name, device ID, biometric ID, facial image, etc.) to a list of known users included in one or more table(s) 618.

With regard to FIG. 7, a flowchart of an illustrative process 700 for deterring a person at a door using a door lock deter light is shown. The process may begin by updating information associated with a smart lock system at step 702 and continue at step 704 by monitoring an area for motion, as shown with regard to FIG. 6. The monitoring may be performed via a sensor or plurality of sensors as described with regard to FIGS. 4-5. At step 706, if motion is not sensed, the process may return to the initial step 702 of updating information associated with the smart lock system. If motion is sensed, the process may continue to step 708 and determine whether the sensed motion corresponds to a person in the area (e.g., person(s) 606 of FIG. 6). If the sensed motion does not correspond to a person, the process may return to the initial step 702 of updating information. If the sensed motion corresponds to a person, the process may continue to step 710 and determine whether the person is a known person (e.g., identified in a whitelist by performing facial recognition, mobile device recognition, or any other technology used to identify a person), as described with regard to FIG. 6. If the person is determined to be a known person at step 710, the process may continue by deactivating an illumination device or transitioning the illumination device to be in a non-deterrence state at step 712 before returning to step 702 of updating information associated with the smart lock system. Alternatively, if the person is determined to be unknown, the illumination device may be activated at step 714, a deterrence audio signal may be optionally output through a speaker at step 716, and the process may continue by returning to step 702.

Updating information at step 702 may include accessing, adding to, or deleting from various information related to the smart lock system (e.g., table 618 of FIG. 6). For example, a person may be identified as an unknown person in step 710 and the illumination device/speaker may be activated in steps 714-716. Before the process returns to step 702, a user of the smart lock system may add the unknown person as a known person to a group or whitelist of known users (as described with regard to FIG. 6), and when the process again reaches step 710, the user may be considered a “known user” such that the process enters step 712 (e.g., deactivating the illumination device or activating/transitioning to be in a non-deterrence state) instead of step(s) 714-716. In another example, a previously unknown person may be added as a known (i.e., authorized) user by the smart lock system automatically (e.g., via a learning system in response to repeated and approved entry into the space). Further, step 702 may include accessing, adding to, or deleting from stored information related to (i) the lock state of one or more locks in the smart lock system and/or (ii) the activation/deactivation state of an alarm system associated with the smart lock system. Step 702 may also include updating specific fields corresponding to the information described above and storing the information in a manner accessible by the smart lock system (e.g., in the memory 406 shown on FIG. 4, on a local hub, or via the cloud).

Further, determining whether the person is a known person at step 708 may include utilizing biometric identifiers (e.g., retina or fingerprint data), mobile device identifiers (e.g., IP address or phone number), geofencing/GPS data, vehicle data (color, make, model, license plate, etc.), and/or additional/alternative information that may be utilized in identifying a person at the door.

In an example, assume a non-human entity (e.g., animal or object) “approaches” the door. After determining whether there has been an update to information associated with the smart lock system at step 702, the area may be monitored for motion in step 704, and motion may be sensed at step 706. At step 708, the system may determine that the sensed motion does not correspond to a person, and the process may exit and return to step 702.

As another example, assume a known person approaches a doorway monitored for motion in step 704. Motion may be sensed at step 706 and it may be determined that a person has been sensed in step 708. The person may be determined to be a known person at step 710 and the illumination device may be deactivated if it is an activated state at step 712. The process may then return to the initial step 702. Alternatively, the illumination device may be turned ON and emit a certain color (e.g., green) indicative of a non-deterrence state at step 712.

In addition, assume an unknown person approaches a doorway monitored for motion. As described above, motion may be sensed at step(s) 704-706 and it may be determined that a person has been sensed in step 708. At step 710, the person may be determined to be an unknown person (e.g., is not included on a list of “known users” as described with regard to FIG. 6). An illumination device may then be activated at step 714 (e.g., as a red ring as shown in FIG. 5) and a deterrence audio signal may be optionally output at step 716 (e.g., a voice stating, “This area is monitored by a 24/7 monitoring service”). The process may then exit and return to step 702.

According to another example, a combination of known and unknown persons may approach a doorway monitored for motion. In this example, the process 700 may begin by updating information at step 702 before sensing motion at step 704. At steps 706-708, it may be determined that multiple people (e.g., two) are located in the area to be monitored. In an example involving a first number of known person(s) and a second number of unknown person(s) approaching the doorway, the process 700 may continue by (i) identifying that at least one person is known at step 710 and continuing to step 712 (non-deterrence state), (ii) identifying that at least one person is unknown at step 710 and continuing to steps 714-716 (deterrence state), (iii) activating a deterrence/non-deterrence state according to the relative numbers of known and unknown persons in the plurality of persons, and so on. In another embodiment, the process 700 (i.e., steps 702-716) may be performed a separate time for each person located at the door. For example, if a known person and an unknown person approach the doorway, the system may first identify one of the persons and perform the process 700 with respect to this first identified person (e.g., activating a deterrence/non-deterrence state in steps 712-716). Then, the process 700 may start again at step 702, identify a second person at the door, and again perform the process 700 with respect to the second identified person (e.g., activating a deterrence/non-deterrence state in steps 712-716). The process 700 may be repeated for a plurality of known/unknown persons who approach the monitored area.

The performance of the steps 702-716 may depend on whether one or more smart locks included in the smart lock system are locked/unlocked. For example, the updating information in step 702 may include determining the lock status of the smart lock securing the exterior door. If the smart lock is unlocked and an unknown person is sensed at step 710, the illumination device may output a deterrence illumination signal at step 714 that varies from some baseline deterrence illumination signal that would have been output irrespective of the lock status of the smart lock. For example, the illumination device may emit softer (i.e., less bright) light at steps 712 or 714, assuming that the unlocked state corresponds to a lack of desire of the smart home user to deter people approaching the door. Alternatively, in another example, the illumination signal may intensify (e.g., become brighter, repeatedly flash, etc.) in response to determining that the smart lock located near the exterior lock interface is unlocked. For example, the system may determine that the user did not lock the door in error (e.g., activated the alarm but not the lock, failed to lock the smart lock after leaving for work despite a routine pattern of doing so, etc.). In this scenario, the illumination signal may be intensified in step 714 from some baseline level to provide a stronger level of deterrence to a potential intruder (e.g., the illumination signal may flash in a red color to indicate an active sensing state). In another example, a person may approach the door while the smart lock is unlocked, and some combination of the illumination device and/or speaker may constitute a deterrence or non-deterrence state associated with the unlocked state of the smart lock. For example, only the light may be activated in step 714 (e.g., speaker turned OFF), or both the light and speaker may be activated (e.g., turned ON) in 714-716. Various additional/alternative deterrence states, non-deterrence states, illumination signal characteristics (e.g., brightness, color), and audio signal characteristics (e.g., volumes, tone, content) may be utilized depending on the lock status of one or more smart locks included in the smart lock system.

Similar to above, the response of the system at steps 712-716 may depend on whether an alarm system of the smart lock system is activated/deactivated. For example, updating information in step 702 may include determining the alarm state of the alarm system (i.e., activated or deactivated). If the alarm system is deactivated and an unknown person is sensed at step 710, for example, the illumination device may output a deterrence illumination signal at step 714 that varies from some baseline deterrence illumination signal that may have been output irrespective of the activation status of the alarm system. In another example, the illumination signal may intensify at step 714 in response to determining that alarm system is deactivated, as described above with regard to lock/unlock states of the included smart locks. Various additional/alternative deterrence states, non-deterrence states, illumination signal characteristics (e.g., brightness, color), and/or audio signal characteristics (e.g., volumes, tone) may be utilized depending on whether the alarm system of the smart lock system is activated/deactivated. Additional deterrence/non-deterrence states that may be activated at steps 712, 714, and 716 may depend on some combination of (i) the lock/unlock status of smart locks included in the system and/or (ii) whether the alarm system is activated/deactivated. For example, a unique deterrence illumination signal may be output at step 714 if (i) multiple smart locks in the smart lock system are unlocked and (ii) the alarm system is simultaneously activated, or in various other scenarios.

FIG. 8 is a “swim-lane” flowchart of an illustrative process 800 for deterring a person at a door and optionally contacting a monitoring service. As described above with regard to FIG. 7, a determination as to whether motion is sensed or detected by a lock/doorbell (e.g., the exterior lock interface 202a of FIG. 2) may be made at step 802. Further, step 802 may include determining whether a device signal (e.g., Bluetooth®, etc.) corresponding to a mobile device of a person (e.g., the mobile device 216 of FIG. 2) is sensed or detected by the lock/doorbell. If motion and/or a device signal is not sensed, the process 800 continues to sense for motion and/or device signal(s) in step 804. While the example shown in FIG. 8 shows steps 802-804 as including sensing/detecting motion and device signal(s), it should be understood that (i) sensing/detecting motion and (ii) sensing/detecting device signal(s) may be performed as separate steps in implementation. After sensing motion/device signals, the process 800 may include identifying a person device using various techniques in steps 806-820. The process may further include activating or deactivating a deterrence state in step 822 and optionally contacting a monitoring service and/or alerting authorities in steps 824-832.

In one example, the process 800 may execute optional steps 806-810 to acquire information related to a mobile device of the person to utilize in identifying the person. At step 806, the lock/doorbell may request or query device information (e.g., a device identifier or ID) related to a mobile device of a person at the door, and the mobile device may access device information (e.g., ID, username) in step 808. The mobile device may transmit the device information back to the lock/doorbell at step 810. The information requested and/or transmitted in steps 806-810 may include a device information such as a phone number, MAC (Media Access Control) address, IMIE (International Mobile Equipment Identity) number, IP address, serial number, and/or any other information related to the mobile device that may be utilized during identification, as further described herein.

In another example, the process 800 may execute optional steps 812-814 to identify a person at the door using data captured by or accessible to the lock/doorbell. As shown in FIG. 8, the process 800 may include capturing an image of the person in step 812 and identifying the person in step 814 by utilizing imaging techniques such as facial recognition. In one example, the lock/doorbell may be configured to perform the identification itself (e.g., via an onboard processor). In another embodiment, other information may be captured by or made accessible to the lock/doorbell in step 812 (e.g., a voice recording via a microphone included in the lock/doorbell, an image captured on security camera configured to communicate with the lock/doorbell, etc.). Further, additional and/or alternative techniques, methods, and/or processes may be performed in step 814 depending on the information acquired during process 800 (e.g., voice recognition utilized in step 814 after capturing a voice recording in step 812, etc.).

In some embodiments, the lock/doorbell may communicate with a hub (e.g., hub 206 of FIG. 2) and/or a cloud server (e.g., server 208 of FIG. 2), and the hub and/or cloud server may perform the identification in one or more of steps 816-820. For example, the lock/doorbell may transmit information (e.g., a captured image, device information, data associated with an onboard identification performed in step 814, etc.) to the hub and/or the cloud server in step 816. If information is transmitted to the hub in step 816, the hub may perform the identification in step 818a. For example, the lock/doorbell may transmit information including a captured image of the person to the hub in step 816, and the hub may identify the person included in the image using facial recognition in step 818a. Further, the hub may transmit information (e.g., whether a person was identified in the image, the identified person's name, other identifiers/information associated with the identified person, etc.) to the lock/doorbell in step 820.

In another example, the lock/doorbell may transmit information (e.g., a captured image, device information, etc.) to the cloud server in step 816. If information is transmitted to the cloud server in step 816, the cloud server may perform the identification in step 818b (e.g., as described above with regard to the hub and step 818a). For example, the lock/doorbell may transmit information including a device identifier (e.g., phone number) associated with a mobile device of the person to the cloud server in step 816, and the cloud server may identify the person (e.g., using the device identifier transmitted in step 816) in step 818b. Further, the cloud server may transmit information (e.g., whether a person was identified in the image, the identified person's name, etc.) to the lock/doorbell in step 820, as described above. In another embodiment, the cloud server may transmit information to the hub in step 820, and this information may be utilized to update activity records (e.g., past attempts to access a home, previous identifications, etc.) by the hub in step 822b, as further described herein.

The signals communicated between the lock/doorbell and hub and/or cloud server in steps 816 and 820 may include device information from steps 806-810 (e.g., phone number, MAC address, etc.), information related to an identified person (e.g., the name of a person identified during step 814), and/or any other information utilized in identifying a person, such as (i) captured images or video (e.g., captured via a sensor onboard the lock/doorbell), (ii) biometric information (e.g., retina scan, fingerprint), (iii) voice/facial recognition data, (iv) RFID/NFC data (e.g., from a fob configured to interact with the lock/doorbell), (v) gesture/behavioral recognition information (e.g., data from gait analysis), (vi) other unique identifiers of a person sensed in the area to be monitored, (vii) information related to the lock/unlock status of smart locks or the activation/deactivation of the smart lock system, and/or more. Further, in any process 800, the person may be identified by utilizing (i) the lock/doorbell (e.g., in step 814), (ii) the hub (e.g., in step 818a), (iii) the cloud server (e.g., in step 818b), or (iv) any combination of the lock/doorbell, hub, and/or cloud server. For example, the lock/doorbell may operate locally and perform the identification via an onboard processor in step 814. In another example, the lock/doorbell may perform a first identification in step 814, and the hub may perform a second identification in step 818a (e.g., for verification, in response to a hardware malfunction, using a different detection technique, etc.).

In an embodiment, the lock/doorbell may be configured to perform facial recognition of a person at the door via the lock/doorbell itself (e.g., in step 814), the hub (e.g., in steps 818a), and/or the cloud server (e.g., in steps 818b). In some embodiments, the lock/doorbell may be configured to transmit information (e.g., via an electronic signal) to the hub and/or cloud server as described above, and this signal may further include information such as captured video data, facial landmarks/features and/or geometry, biometric data, environmental and contextual information, or any other information/data that may be useful in performing facial recognition. The information utilized in performing the identification in any of steps 808-812 may be collected via the lock/doorbell (e.g., using an onboard sensor), another device associated with the smart lock system (e.g., a security camera), publicly available sources (e.g., local police records, Facebook®, etc.), or through any other source or means.

Depending on whether motion and/or device signal(s) are sensed in steps 802-804 and a person is identified in steps 812-820, the lock/doorbell may activate or deactivate a deterrence (or non-deterrence) state of the lock/doorbell at step 822a, as described above with regard to FIGS. 4-7. Further, in step 822b, the hub may update activity records associated with the smart lock system of the lock/doorbell. For example, if a person is identified near the lock/doorbell, the hub may receive information related to the identification (e.g., identified person's name, date/time, etc.) in step 820, and this information may be stored in a memory of the hub in step 822b.

If a person has a problem with someone (e.g., the person is a stalker or ex-spouse), the lock/doorbell may be configured to transmit information associated with and/or indicative of a specific person in step 824 that may be received by a monitoring service (e.g., monitoring service 428 of FIG. 4). In an embodiment, such people may be stored in a “blacklist” or other type of list that stores specific information (e.g., ex-spouse, court order type, etc.) and causes the lock/doorbell to communicate such information with the monitoring service. More specifically, the information transmitted in step 824 may include any information related to the identification of the person (e.g., as described above regarding the information transmitted in steps 816 and 820) and/or any other information that may be utilized by the monitoring service (e.g., relationship status, such as “ex-spouse,” device information, information related to the alarm state of the alarm system, etc.). For example, assume that a person was identified as a “banned user” on a “blacklist” (as described with regard to table 618 of FIG. 6) at step 814 (e.g., a stalker who has received a no-contact order from an authorized user of the smart home system). The lock/doorbell may transmit information related to the stalker to the monitoring service in step 824, and the monitoring service may attempt to communicate with a resident of the home in step 826 (e.g., by placing a call to a phone number associated with a resident of the home). The monitoring service may also attempt to communicate with the person identified by the process 800 in step 828 (e.g., by sending a message to the lock/doorbell). Depending on information received during step 826 and/or 828 (e.g., whether an authorized user of the smart home system has responded to a call and approved entry), the monitoring service may deescalate or escalate in step 830 (e.g., clear or elevate an entry associated with an identification of a person). If the monitoring service escalates in step 830 (e.g., receives no response to communications in steps 826 and/or 828), the monitoring service may continue to step 832 and optionally alert authorities to the presence of the identified person. The decision of whether to alert authorities at step 832 may include consideration of (i) the applicable laws of the jurisdiction in which the smart lock system is located, (ii) court or police records, (iii) past instances of identification by the lock/doorbell, (iv), and various additional/alternative sources of information and/or data.

The monitoring service may be a residential security monitoring service, commercial security monitoring service, emergency response service, law enforcement liaison service, home automation control center, third-party monitoring platform, remote access control service, data analysis and reporting service, or any other monitoring service. The information transmitted via the monitoring service (e.g., in steps 826-828) may be transmitted via an I/O unit or antenna of the doorbell/lock (e.g., as described with regard to the I/O unit 408 and antenna 414 of FIG. 4) or otherwise (e.g., via the hub or cloud server). The information may include information configured to be utilized by the monitoring service, such as a person's name, a device identifier, a smart lock user's preferences, GPS/location information, and/or more. As an example, assume a person has been identified as a person included on a user's “blacklist” (e.g., an ex-husband who has received a temporary restraining order (TRO) preventing the ex-husband from contacting an authorized user of a smart lock system). The information transmitted between the doorbell/lock and the monitoring service may include the name of the ex-husband, a sensed image of a person believed to be the ex-husband, data related to past attempts at entering the area secured by the smart lock system, court records, device or location information related to the ex-husband's phone, and more. The monitoring service may receive and utilize such information for a variety of uses including determining whether to contact public authorities (e.g., police), verifying that the identified person is actually the person included on the blacklist, and so on.

Systems and methods for deterring a person at a door using a door lock deter light are disclosed. One method of deterring an unknown person at a door includes sensing that a person approaches a door at which an exterior door lock interface including an illumination device is located. The method further includes determining whether the person is unknown and, in response to determining that the person is unknown, activating the illumination device on the exterior door lock interface to be in a deterrence state. Otherwise, the method may further include activating the illumination device to be in a non-deterrence state or maintaining the illumination device in a deactivated state.

Sensing that a person approaches the door may further include capturing at least one image inclusive of the person and determining that the person captured in the at least one image is positioned proximate to the door.

Sensing that a person approaches the door may further include sensing distance of a person from the door to be within a predetermined distance.

In an embodiment, the method may further include establishing a predetermined zone in an image frame of a camera disposed on the exterior door lock interface at which packages are to be delivered. In response to sensing that the person is in the predetermined zone in which a package is determined to be positioned, the method may further include activating the illumination device to the deterrence state.

The method may further include generating a deterrence audio signal and outputting the deterrence audio signal while the illumination device is in the deterrence state.

The method may further include determining whether the person is (i) identified and (ii) approved by an authorized user of the exterior door lock interface. In response to determining that the person is (i) identified and (ii) approved by the user, the method may further include deactivating the illumination device to be in a non-deterrence state if in the deterrence state. Otherwise, the method may include activating the illumination device to be in the deterrence state.

Sensing that a person approaches the door may include determining that a known mobile electronic device crosses a geofence, and if not, activating the illumination device to be in the deterrence state.

In response to sensing that a person approaches the door, the method may further include activating the illumination device to illuminate in an active sensing state indicative of a sensor actively being utilized to sense the person.

In an embodiment, the method may include determining whether an identifier associated with the electronic device is registered as an approved identifier in response to sensing a wireless signal of an electronic device with the person approaching the door. In response to determining that the identifier is not registered, the method may include further activating the illumination device to be in the deterrence state. Otherwise, the method may include deactivating the illumination device to be in a non-deterrence state if in the deterrence state.

The method may further include storing an identification of a known person that a user of the exterior door lock interface wants to notify a monitoring service or public authority that the known person approaches the door. In response to determining that the person is the known person, the method may further include generating a message indicative of the identity of the known person and communicating the message to cause a notification to be communicated to the monitoring service or public authority.

One embodiment of a system for deterring a person at a door using a door lock deter light includes an exterior door lock interface at the door. The exterior lock interface may include an illumination device and electronics including a sensor and at least one processor. The electronics may be configured to sense, by the sensor, whether a person approaches the door and determine, by the processor(s), whether the person is unknown. In response to determining that the person is unknown, the electronics may be configured to activate, by the processor(s), the illumination device on the exterior door lock interface to be in a deterrence state. Otherwise, the electronics may be configured to deactivate, by the processor(s), the illumination device to be in a non-deterrence state or maintain, by the processor(s), the illumination device in a deactivated state.

In sensing that a person approaches the door, the electronics may be further configured to capture at least one image inclusive of the person and determine that the person captured in the at least one image is positioned proximate to the door.

In sensing that a person approaches the door, the electronics may be further configured to sense distance of a person from the door to be within a predetermined distance.

The system may further include at least one predetermined zone in an image frame of a camera disposed on the exterior door lock interface at which packages are to be delivered. The electronics may be further configured to activate the illumination device to be in the deterrence state if in a non-deterrence state in response to sensing that the person is in the predetermined zone in which a package is determined to be positioned.

In an embodiment, the system may further include a speaker in communication with the electronics. The electronics may be further configured to generate a deterrence audio signal and output the deterrence audio signal to the speaker while the illumination device is in the deterrence state to cause an audible signal to be heard by the person.

The system may further include at least one predetermined zone established by the user within which the user is to be identified when approaching the door. In response to sensing that the person approaches the door within the predetermined zone and is identified by being captured in an image, the electronics may be further configured to deactivate the illumination device to be in a non-deterrence state if in the deterrence state.

In another embodiment, the electronics may further include a non-transitory memory configured to store information associated with at least one person to be identified and approved. The electronics may be further configured to determine whether the person is identified and approved and, in response to determining that the person is identified and approved, to deactivate the illumination device to be in a non-deterrence state if in the deterrence state. Otherwise, the electronics may be configured to activate the illumination device to be in the deterrence state if in the non-deterrence state.

In an embodiment, the electronics may further include an antenna and signal processor. The electronics may be further configured to sense a wireless signal of an electronic device with the person approaching the door and determine whether an identifier associated with the electronic device is registered as an approved identifier. In response to determining that the identifier is not registered, the electronics may be further configured to activate the illumination device to be in the deterrence state if in a non-deterrence state. Otherwise, the electronics may be further configured to deactivate the illumination device to be in the non-deterrence state.

The electronics may be further configured to store, in a non-transitory memory, an identification of a known person that a user of the exterior door lock interface wants to notify a monitoring service or public authority that the known person approaches the door. In response to determining that the person is the known person, the electronics may be further configured to generate a message indicative of the identity of the known person and communicate the message to cause a notification to be communicated to the monitoring service or public authority.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments. These features and advantages of the embodiments will become more fully apparent from the following description and appended claims or may be learned by the practice of embodiments as set forth hereinafter.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules to emphasize their implementation independence more particularly. For example, a module may be implemented as a hardware circuit comprising custom very large scale integrated (“VLSI”) circuits or gate arrays, off-the-shelf semiconductor circuits such as logic chips, transistors, or other discrete components. A module may also be implemented in programmable hardware devices such as an FPGA, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules and may be embodied in any suitable for and/organized within any suitable type of data structure. The operational data may be collected as a single data set or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a server, cloud storage (which may include one or more services in the same or separate locations), a hard disk, a solid state drive (“SSD”), an SD card, a random access memory (“RAM”), a read-only memory (“ROM”), an erasable programmable read-only memory (“EPROM” or Flash memory), a static random access memory (“SRAM”), a Blu-ray disk, a memory stick, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, a personal area network, a wireless mesh network, and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the C programming language or similar programming languages.

The computer readable program instructions may execute entirely on the user's computer, partly on the user's computer, as a stand-alone software package, partly on the user's computer and partly on a remote computer 125 or service or entirely on the remote computer 125 or server or set of servers. In the latter scenario, the remote computer 125 may be connected to the user's computer through any type of network, including the network types previously listed. Alternatively, the connection may be made to an external computer (for example, through the Internet using an Internet Service Provider). In some embodiments, electronic circuitry including, for example, programmable logic circuitry, FPGA, or programmable logic arrays (“PLA”) may execute the computer readable program instructions by utilizing state information of the computer readable program instructions to personalize the electronic circuitry to perform aspects of the present invention.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical functions.

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

As used herein, a list with a conjunction of and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Means for performing the steps described herein, in various embodiments, may include one or more of a sliding door lock, a sliding door, a window, a network interface, a processor (e.g., a CPU, a processor core, an FPGA or other programmable logic, an ASIC, a controller, a microcontroller, and/or another semiconductor integrated circuit device), an HDMI or other electronic display dongle, a hardware appliance or other hardware device, other logic hardware, and/or other executable code stored on a computer readable storage medium. Other embodiments may include similar or equivalent means for performing the steps described herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The foregoing method descriptions and the process flow diagrams are provided merely as illustrative examples and are not intended to require or imply that the steps of the various embodiments must be performed in the order presented. As will be appreciated by one of skill in the art the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the principles of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the invention. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

While the instant disclosure has been described above according to its preferred embodiments, it can be modified within the spirit and scope of this disclosure. This application is therefore intended to cover any variations, uses, or adaptations of the instant disclosure using the general principles disclosed herein. Further, the instant application is intended to cover such departures from the present disclosure as come within the known or customary practice in the art to which this disclosure pertains.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It is noted that any element disclosed in one embodiment may be incorporated or utilized with any other embodiment disclosed herein.

What is claimed is:

1. A method of deterring an unknown person at a door, said method comprising:
sensing that a person approaches a door at which an exterior door lock interface inclusive of an illumination device is located;
determining whether the person is unknown; and
in response to determining that the person is unknown, activating the illumination device on the exterior door lock interface to be in a deterrence state,
otherwise, deactivating the illumination device to be in a non-deterrence state or maintaining the illumination device in a deactivated state.

2. The method according to claim 1, wherein sensing that a person approaches the door includes:
capturing at least one image inclusive of the person; and
determining that the person captured in the at least one image is positioned proximate to the door.

3. The method according to claim 1, wherein sensing that a person approaches the door includes sensing distance of a person from the door to be within a predetermined distance.

4. The method according to claim 1, further comprising:
establishing a predetermined zone in an image frame of a camera disposed on the exterior door lock interface at which packages are to be delivered; and
in response to sensing that the person is in the predetermined zone in which a package is determined to be positioned, activating the illumination device to be in the deterrence state.

5. The method according to claim 4, further comprising:
generating a deterrence audio signal; and
outputting the deterrence audio signal while the illumination device is in the deterrence state.

6. The method according to claim 1, further comprising:
establishing a predetermined zone within which the person is to be identified when approaching the door; and
in response to sensing that the person approaches the door within the predetermined zone and is identified as a known person in a captured image, deactivating the illumination device to be in the non-deterrence state if in the deterrence state.

7. The method according to claim 1, further comprising:
determining whether the person is (i) identified and (ii) approved by an authorized user of the exterior door lock interface; and
in response to determining that the person is (i) identified and (ii) approved by a user, deactivating the illumination device to be in the non-deterrence state if in the deterrence state,
otherwise, activating the illumination device to be in the deterrence state.

8. The method according to claim 1, wherein sensing that a person approaches the door includes determining that a known mobile electronic devices crosses a geofence, and if not, activating the illumination device to be in the deterrence state.

9. The method according to claim 1, further comprising, in response to sensing that a person approaches the door, activating the illumination device to illuminate in an active sensing state indicative of a sensor actively being utilized to sense the person.

10. The method according to claim 1, further comprising:
in response to sensing a wireless signal of an electronic device with the person approaching the door, determining whether an identifier associated with the electronic device is registered as an approved identifier; and
in response to determining that the identifier is not registered, activating the illumination device to be in the deterrence state,
otherwise, deactivating the illumination device to be in the non-deterrence state if in the deterrence state.

11. The method according to claim 1, further comprising:
storing an identification of a known person that a user of the exterior door lock interface wants to notify a monitoring service or public authority that the known person approaches the door;
in response to determining that the person is the known person, generating a message indicative of the identification of the known person; and
communicating the message to cause a notification to be communicated to the monitoring service or public authority.

12. A system for deterring an unknown person at a door, said system comprising:
an exterior door lock interface at the door including:
an illumination device; and
electronics including a sensor and at least one processor, and configured to:
sense, by the sensor, whether a person approaches the door;
determine, by the at least one processor, whether the person is unknown; and
in response to determining that the person is unknown, activate, by the at least one processor, the illumination device on the exterior door lock interface to be in a deterrence state,
otherwise, deactivate the illumination device to be in a non-deterrence state or maintain the illumination device in a deactivated state.

13. The system according to claim 12, wherein the electronics, in sensing that a person approaches the door, are further configured to:
capture at least one image inclusive of the person; and
determine that the person captured in the at least one image is positioned proximate to the door.

14. The system according to claim 13, wherein the electronics, in sensing that a person approaches the door, are further configured to sense distance of a person from the door to be within a predetermined distance.

15. The system according to claim 12, further comprising at least one predetermined zone in an image frame of a camera disposed on the exterior door lock interface at which packages are to be delivered, and wherein the electronics are further configured to activate the illumination device to be in the deterrence state if in a non-deterrence state in response to sensing that the person is in the predetermined zone in which a package is determined to be positioned.

16. The system according to claim 15, further comprising a speaker in communication with the electronics, and wherein the electronics are further configured to:
generate a deterrence audio signal; and
output the deterrence audio signal to the speaker while the illumination device is in the deterrence state to cause an audible signal to be heard by the person.

17. The system according to claim 12, further comprising:
at least one predetermined zone established by a user within which the person is to be identified when approaching the door; and
wherein the electronics are further configured to, in response to sensing that the person approaches the door within the predetermined zone and is identified by being captured in an image, deactivate the illumination device to be in a non-deterrence state if in the deterrence state.

18. The system according to claim 12, wherein the electronics further include a non-transitory memory configured to store information associated with at least one person to be identified and approved, and wherein the electronics are further configured to:
determine whether the person is identified and approved; and
in response to determining that the person is identified and approved, deactivate the illumination device to be in a non-deterrence state if in the deterrence state;
otherwise, activate the illumination device to be in the deterrence state if in the non-deterrence state.

19. The system according to claim 12, wherein the electronics further include an antenna and signal processor, and are further configured to:
sense a wireless signal of an electronic device with the person approaching the door;
determine whether an identifier associated with the electronic device is registered as an approved identifier; and
in response to determining that the identifier is not registered, activate the illumination device to be in the deterrence state if in a non-deterrence state,
otherwise, deactivate the illumination device to be in the non-deterrence state.

20. The system according to claim 12, wherein the electronics are further configured to:
store, in a non-transitory memory, an identification of a known person that a user of the exterior door lock interface wants to notify a monitoring service or public authority that the known person approaches the door;
in response to determining that the person is the known person, generate a message indicative of the identification of the known person; and
communicate the message to cause a notification to be communicated to the monitoring service or public authority.
